(19) United States
(12) Patent Application Publication
(10) Pub. No.: US 2025/0271634 A1
(43) Pub. Date: Aug. 28, 2025

(54) OPTICAL REFLECTION ELEMENT

(71) Applicant: Panasonic Intellectual Property Management Co., Ltd., Osaka (JP)

(72) Inventors: Jun TAKIGAWA, Osaka (JP); Kensuke MIHARA, Osaka (JP)

(21) Appl. No.: 19/207,008

(22) Filed: May 13, 2025

Related U.S. Application Data
(63) Continuation of application No. PCT/JP2023/032065, filed on Sep. 1, 2023.

(30) Foreign Application Priority Data
Nov. 30, 2022 (JP) 2022-191144

(51) Int. Cl. G02B 7/182; G02B 26/08

(52) U.S. Cl. CPC G02B 7/1821; G02B 26/0816

(57) ABSTRACT

An optical reflection element includes: a fixation part; and a movable part supported by the fixation part so as to be rotatable about a rotation axis, having a reflection surface on a center portion of an upper surface thereof, and having a rib portion on an outer peripheral region of a lower surface thereof. The center portion of the movable part has a structure in which a base layer and an oxide film are removed from an SOI wafer in which the base layer, the oxide film, and an active layer are stacked, and the rib portion has a structure in which at least a part of the active layer is removed from the SOI wafer.

### CROSS REFERENCE TO RELATED APPLICATION

This application is a continuation of International Application No. PCT/JP2023/032065 filed on Sep. 1, 2023, entitled “OPTICAL REFLECTION ELEMENT”, which claims priority under 35 U.S.C. Section 119 of Japanese Patent Application No. 2022-191144 filed on Nov. 30, 2022, entitled “OPTICAL REFLECTION ELEMENT”. The disclosures of the above applications are incorporated herein by reference.

### BACKGROUND OF THE INVENTION

### Field of the Invention

The present invention relates to an optical reflection element that includes a movable part having a reflection surface formed thereon.

### Description of Related Art

An optical reflection element that includes a movable part having a reflection surface formed thereon has been known. In this type of optical reflection element, for example, a reflection surface is located on a movable part that rotates about a rotation axis, and scanning is performed with a beam incident on the reflection surface as the movable part rotates.

Japanese Laid-Open Patent Publication No. 2013-222155 describes an optical scanner that includes: a movable body that can oscillate around an axis; and a drive means for oscillating the movable body around the axis. The movable body includes a light-reflecting plate and a support frame that surrounds the light-reflecting plate and is thicker than the light-reflecting plate. The respective parts of the optical scanner are formed by removing unnecessary portions of an SOI (silicon on insulator) wafer using various etching methods such as dry etching and wet etching.

In the production of the SOI wafer, a base layer is thermally oxidized at a temperature of about 1100° C. to form an oxide film on the surface of the base layer, and an active layer is then bonded to the oxide film. The base layer has a higher thermal expansion coefficient than the oxide film, and when the base layer returns to room temperature, the base layer attempts to shrink more than the oxide film. Thus, at this time, compressive stress is applied from the base layer to the oxide film. When such an SOI wafer is processed to remove the base layer and the oxide film from a center region of the movable part and form a rib portion in an outer peripheral region, the above compressive stress applied to the oxide film of the rib portion is partially released due to the removal of the base layer in the center region, and the oxide film expands. Accordingly, a force is applied from the oxide film to the active layer in a center portion in a direction toward the center of the center portion, and bending occurs in the active layer in the center portion.

### SUMMARY OF THE INVENTION

An optical reflection element according to a main aspect of the present invention includes: a fixation part; and a movable part supported by the fixation part so as to be rotatable about a rotation axis, having a reflection surface on a center portion of an upper surface thereof, and having a rib portion on an outer peripheral region of a lower surface thereof. The center portion of the movable part has a structure in which a base layer and an oxide film are removed from an SOI wafer in which the base layer, the oxide film, and an active layer are stacked, and the rib portion has a structure in which at least a part of the active layer is removed from the SOI wafer.

In the production of the SOI wafer, the base layer is thermally oxidized at about 1100° C. to form the oxide film on the surface of the base layer, and the active layer is then bonded to the oxide film. The base layer has a higher thermal expansion coefficient than the oxide film, and when the base layer returns to room temperature, the base layer attempts to shrink more than the oxide film. Thus, at this time, compressive stress is applied from the base layer to the oxide film. When such an SOI wafer is processed to remove the base layer and the oxide film from the center region of the movable part and form the rib portion in the outer peripheral region, the above compressive stress applied to the oxide film of the rib portion is partially released due to the removal of the base layer in the center region, so that the oxide film expands. Accordingly, a force is applied from the oxide film to the active layer of the center portion in a direction toward the center of the center portion, so that bending occurs in the active layer of the center portion. In contrast, in the optical reflection element according to this aspect, since at least a part of the active layer is removed in the rib portion, the expansion of the oxide film is less likely to propagate to the active layer, so that bending is less likely to occur in the active layer of the center portion. Therefore, when forming the rib portion in the movable part using the SOI wafer, bending of the movable part can be suppressed.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1 is a plan view schematically showing a configuration of an optical reflection element according to Embodiment 1;

FIG. 2A to FIG. 2D are cross-sectional views showing a procedure for producing an SOI wafer;

FIG. 3A and FIG. 3B are respectively a plan view and a cross-sectional view schematically showing a configuration of a movable part according to Comparative Example 1;

FIG. 4A to FIG. 4C are cross-sectional views showing a procedure for forming a movable part according to Embodiment 1;

FIG. 5A and FIG. 5B are respectively a plan view and a cross-sectional view schematically showing a configuration of the movable part according to Embodiment 1;

FIG. 6 is a graph showing simulation results for a bending amount according to Comparative Example 1 and Embodiment 1;

FIG. 7A and FIG. 7B are respectively a plan view and a cross-sectional view schematically showing a configuration of a movable part according to Modification 1 of Embodiment 1;

FIG. 8A and FIG. 8B are respectively a plan view and a cross-sectional view schematically showing a configuration of a movable part according to Modification 2 of Embodiment 1;

FIG. 9 is a graph showing simulation results for a bending amount according to Embodiment 1 and Modification 2 of Embodiment 1;

FIG. 10A and FIG. 10B are respectively a plan view and a cross-sectional view schematically showing a configuration of a movable part according to Modification 3 of Embodiment 1;

FIG. 11A and FIG. 11B are respectively a plan view and a cross-sectional view schematically showing a configuration of a movable part according to Embodiment 2;

FIG. 12 is a graph showing simulation results for a bending amount according to Modification 2 of Embodiment 1 and Embodiment 2;

FIG. 13A to FIG. 13C are each a plan view schematically showing a configuration of a movable part according to a modification of Embodiment 2

FIG. 14A to FIG. 14C are each a plan view schematically showing a configuration of a movable part according to a modification of Embodiment 2;

FIG. 15A to FIG. 15C are each a plan view schematically showing a configuration of a movable part according to a modification of Embodiment 2;

FIG. 16A and FIG. 16B are each a plan view schematically showing a configuration of a movable part according to a modification of Embodiment 2;

FIG. 17A and FIG. 17B are respectively a plan view and a cross-sectional view schematically showing a configuration of a movable part according to a modification of Embodiment 2;

FIG. 18A and FIG. 18B are respectively a plan view and a cross-sectional view schematically showing a configuration of a movable part according to Embodiment 3;

FIG. 19A to FIG. 19C are each a plan view schematically showing a configuration of a movable part according to a modification of Embodiment 3;

FIG. 20A to FIG. 20C are each a plan view schematically showing a configuration of a movable part according to Modification 1 of the movable part;

FIG. 21A to FIG. 21C are each a plan view schematically showing a configuration of a movable part according to Modification 1 of the movable part;

FIG. 22A to FIG. 22C are each a plan view schematically showing a configuration of a movable part according to Modification 2 of the movable part;

FIG. 23A to FIG. 23C are each a plan view schematically showing a configuration of a movable part according to Modification 2 of the movable part;

FIG. 24A is a plan view schematically showing a configuration of a movable part according to simulation of Comparative Example 2;

FIG. 24B shows a simulation result showing a bending amount of a center portion during rotation of the movable part according to Comparative Example 2;

FIG. 25A is a plan view schematically showing a configuration of a movable part according to simulation of Embodiment 2.

FIG. 25B shows a simulation result showing a bending amount of a center portion during rotation of the movable part according to Embodiment 2;

FIG. 26 is a graph showing simulation results for a bending amount according to Comparative Example 2 and Embodiment 2;

FIG. 27A and FIG. 27B are respectively a plan view and a cross-sectional view schematically showing a configuration of a movable part according to a modification of a reflection surface;

FIG. 28 is a plan view schematically showing a configuration of an optical reflection element according to a modification of vibration parts; and

FIG. 29A and FIG. 29B are respectively a plan view and a cross-sectional view schematically showing a configuration of a movable part according to another modification.

### DETAILED DESCRIPTION

Hereinafter, embodiments of the present invention will be described with reference to the drawings. For convenience, in each drawing, X, Y, and Z axes that are orthogonal to each other are additionally shown. The Z-axis positive direction is the vertical upward direction.

### Embodiment 1

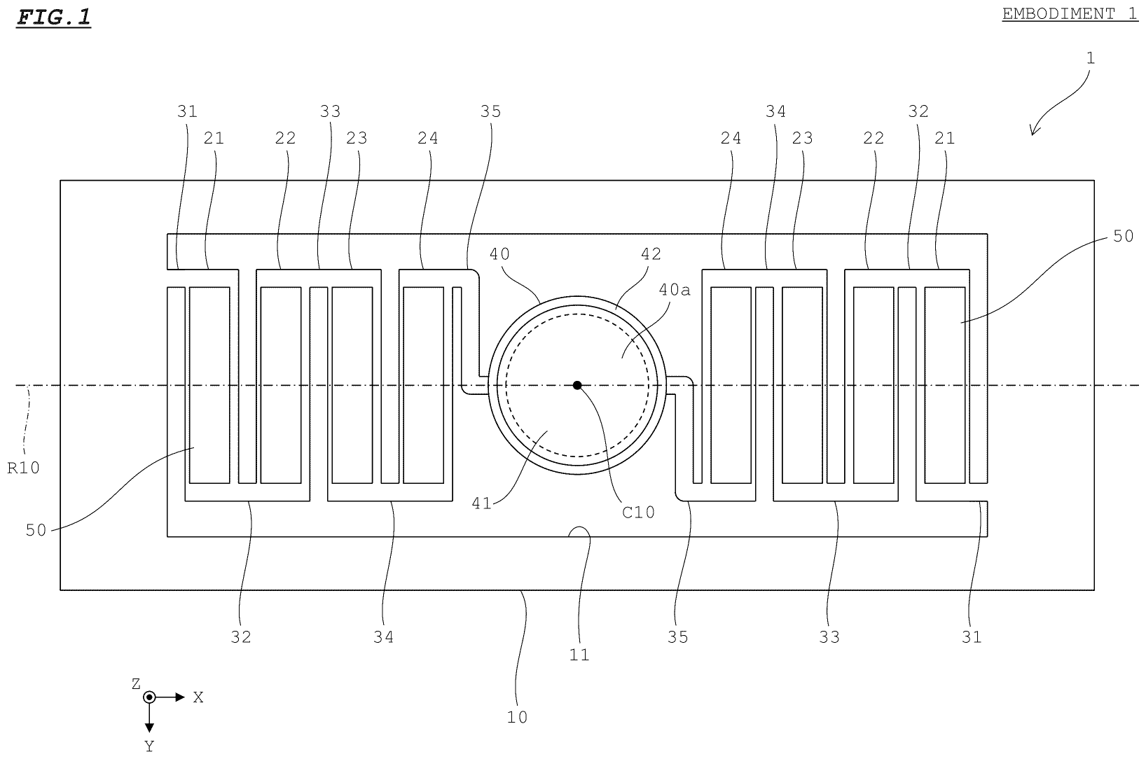

FIG. 1 is a plan view schematically showing a configuration of an optical reflection element 1.

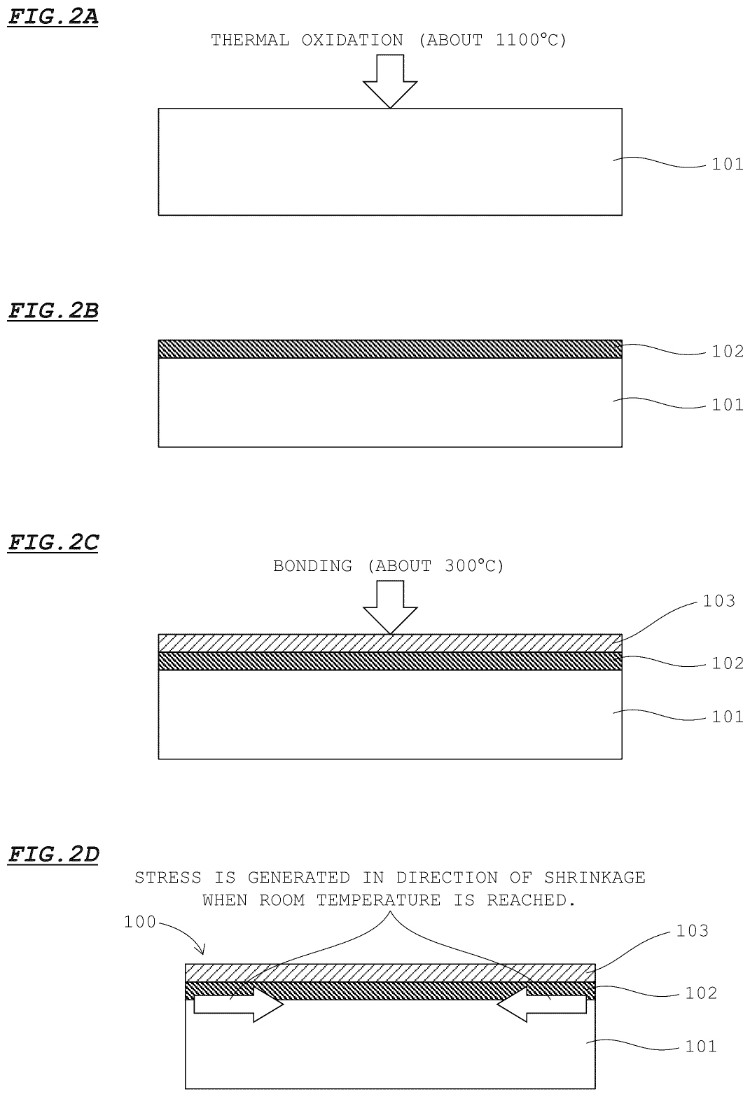

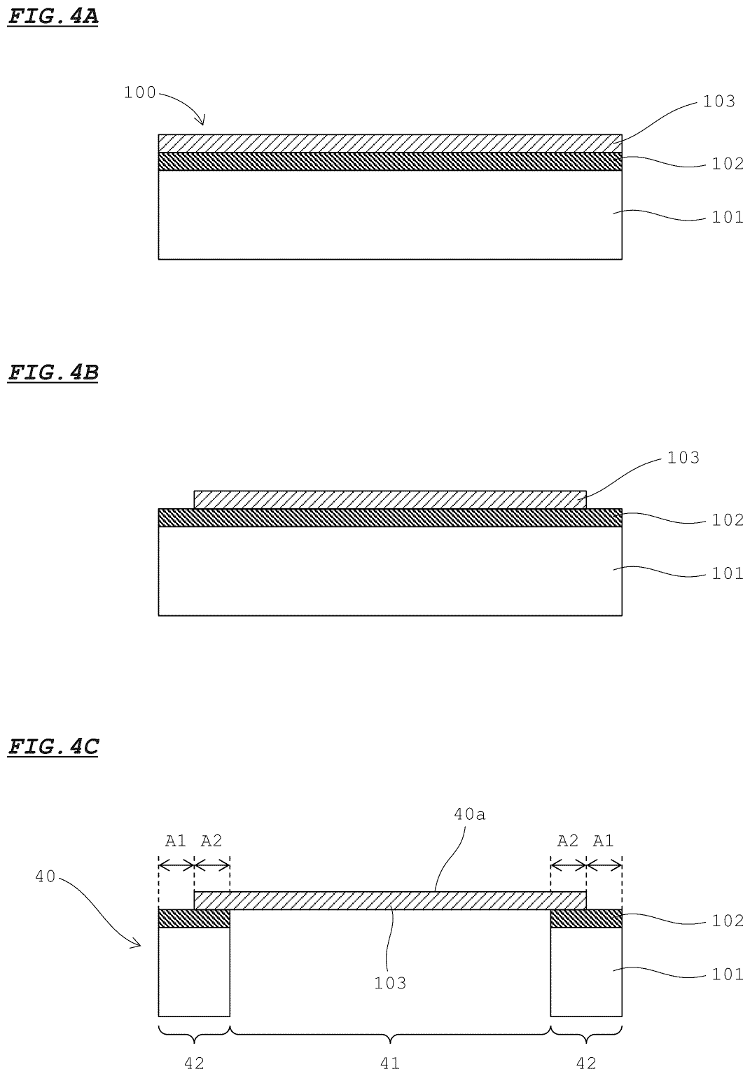

The optical reflection element 1 includes a fixation part 10, a pair of sets of vibration parts 21 to 24, a pair of sets of connection parts 31 to 34, a pair of coupling beams 35, a movable part 40, and eight drive parts 50. The optical reflection element 1 is configured to be point-symmetrical about a center C10. The optical reflection element 1 is formed by processing an SOI wafer 100 (see FIG. 4A). The production and processing of the SOI wafer 100 will be described later with reference to FIG. 2A to FIG. 2D and FIG. 4A to FIG. 4C.

The fixation part 10 is configured in a frame shape. The pair of sets of vibration parts 21 to 24, the pair of sets of connection parts 31 to 34, and the pair of coupling beams 35 are located in an opening 11 that penetrates the fixation part 10 in the Z-axis direction at the center of the fixation part 10 in a plan view, and are placed between the fixation part 10 and the movable part 40. On each of the X-axis positive side and the X-axis negative side of the movable part 40, a set consisting of the vibration parts 21 to 24, the connection parts 31 to 34, and the coupling beam 35 is placed. The vibration parts 21 to 24 located on the X-axis positive side or the X-axis negative side of the movable part 40 have a meander shape in a plan view.

The movable part 40 has a circular shape in a plan view. The movable part 40 is supported by the fixation part 10 via the pair of sets of vibration parts 21 to 24, the pair of sets of connection parts 31 to 34, and the pair of coupling beams 35 so as to be rotatable about a rotation axis R10. The center of the movable part 40 coincides with the position of the center C10 of the optical reflection element 1. The movable part 40 has a center portion 41 in a center region thereof and has a rib portion 42 in an outer peripheral region of a lower surface thereof. The rib portion 42 has a structure that protrudes in the Z-axis negative direction with respect to the center portion 41.

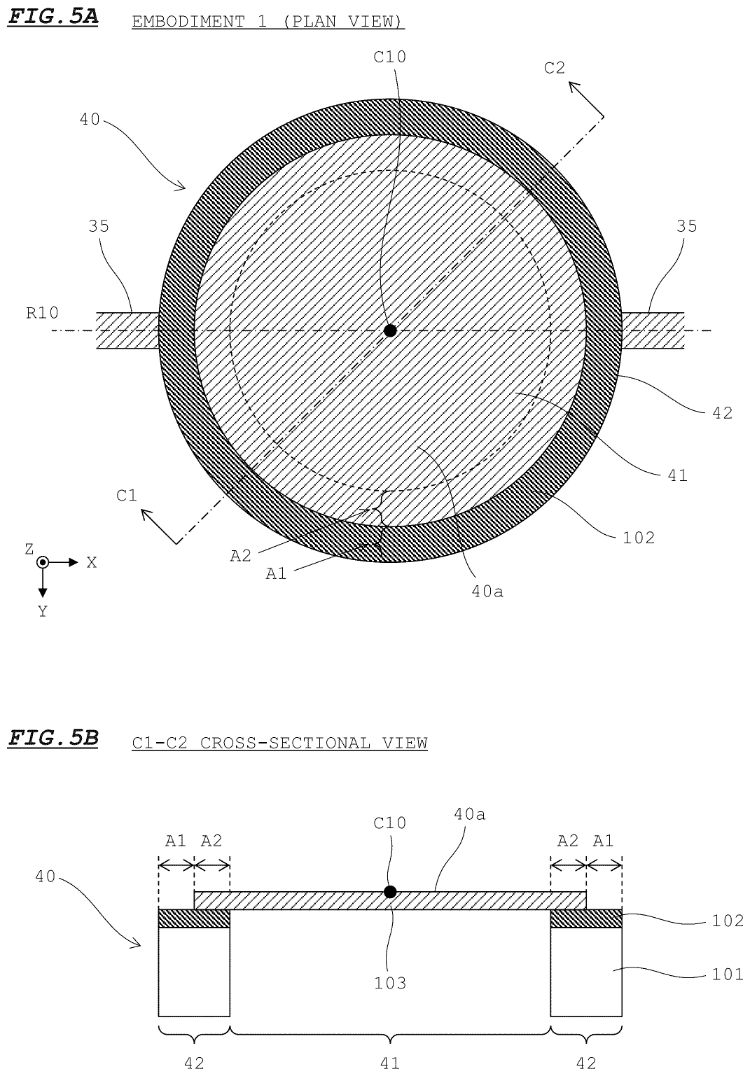

The upper surface of the movable part 40 (the upper surface of an active layer 103 described later) is a reflection surface 40a that reflects light. Normally, the upper surface of the active layer 103 has a sufficient reflectance as a result of the production of the SOI wafer 100, so that the upper surface of the active layer 103 can be used as the reflection surface 40a. If the reflectance of the upper surface of the active layer 103 is insufficient, the reflectance of the upper surface of the active layer 103 may be increased by polishing the upper surface of the active layer 103. The configuration of the movable part 40 will be described later with reference to FIG. 4A to FIG. 5B.

The drive parts 50 are placed on the upper surfaces of the pair of sets of vibration parts 21 to 24, respectively. Each drive part 50 has a layer structure composed of a lower electrode layer, a piezoelectric layer, and an upper electrode layer. The drive parts 50 are connected to electrodes on the fixation part 10 via wires on the vibration parts 21 to 24, the connection parts 31 to 34, and the fixation part 10. Cables (external wires) connected to an external device are connected to the electrodes on the fixation part 10 by wire bonding.

When drive voltages having the same phase are applied to the drive parts 50 on the vibration parts 21 and 23, the piezoelectric layers in the drive parts 50 on the vibration parts 21 and 23 become deformed due to an inverse piezoelectric effect, so that the vibration parts 21 and 23 vibrate so as to bend. Meanwhile, when drive voltages having a phase opposite to that of the drive voltages applied to the drive parts 50 on the vibration parts 21 and 23 are applied to the drive parts 50 on the vibration parts 22 and 24, the piezoelectric layers in the drive parts 50 on the vibration parts 22 and 24 become deformed due to an inverse piezoelectric effect, so that the vibration parts 22 and 24 become deformed so as to bend. Accordingly, due to the deformation of the vibration parts 21 to 24, the movable part 40 rotates about the rotation axis R10.

FIG. 2A to 2D are cross-sectional views showing a procedure for producing the SOI wafer 100.

As shown in FIG. 2A, thermal oxidation treatment is performed at about 1100° C. on a base layer 101 made of silicon (Si). Accordingly, as shown in FIG. 2B, an oxide film 102 made of silicon dioxide (SiO₂) is formed on the surface of the base layer 101. For convenience, only the oxide film 102 formed on the upper surface of the base layer 101 is shown in FIG. 2B.

Subsequently, as shown in FIG. 2C, the active layer 103 made of silicon (Si) is bonded to the upper surface of the oxide film 102 at about 300° C. in a structure of the base layer 101 and the oxide film 102 in FIG. 2B. Thus, the SOI wafer 100 is completed.

Then, when the SOI wafer 100 is returned to room temperature, the SOI wafer 100 shrinks in a direction parallel to the surface thereof as shown in FIG. 2D. At this time, since the linear thermal expansion coefficient of the base layer 101 (Si) is 3.9×10⁻⁶ and the linear thermal expansion coefficient of the oxide film 102 (SiO₂) is 0.5×10⁻⁶, the base layer 101 shrinks more easily than the oxide film 102. Accordingly, compressive stress is applied from the base layer 101 to the oxide film 102.

Meanwhile, when the movable part 40 is formed by processing the SOI wafer 100 produced as described above, bending occurs in the center portion 41 of the movable part 40, and bending also occurs in the reflection surface 40a which is the upper surface of the movable part 40. In this case, light incident on the reflection surface 40a cannot be reflected properly. Hereinafter, the fact that bending can occur in the upper surface of the movable part 40 will be described with reference to Comparative Example 1.

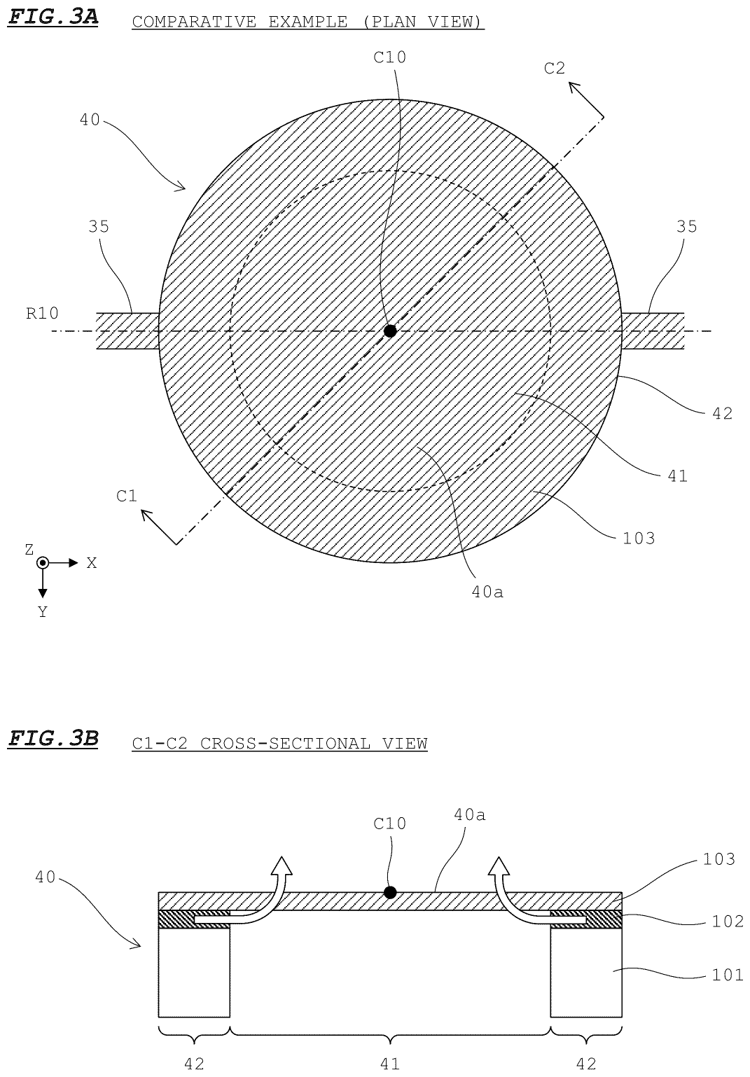

FIG. 3A and FIG. 3B are respectively a plan view and a cross-sectional view schematically showing a configuration of a movable part 40 according to Comparative Example 1. FIG. 3B is a C1-C2 cross-sectional view in the plan view in FIG. 3A.

In the plan view shown in FIG. 3A, for convenience, the same material as in the cross-sectional view shown in FIG. 3B is shown by the same oblique lines as in FIG. 3B. In the following drawings as well, when a plan view and a cross-sectional view are shown together, the same material is shown by the same oblique lines.

As shown in FIG. 3A and FIG. 3B, the center portion 41 of the movable part 40 is composed of the active layer 103. The rib portion 42 of the movable part 40 is composed of the base layer 101, the oxide film 102, and the active layer 103.

Such a movable part 40 of Comparative Example 1 is formed by removing the base layer 101 and the oxide film 102 in a center region of the lower surface of the SOI wafer 100 shown in FIG. 2D by etching. However, as described with reference to FIG. 2D, when the environmental temperature is returned to room temperature, the oxide film 102 receives a force in the direction of shrinkage due to the compressive stress of the base layer 101. That is, at room temperature, the oxide film 102 is in a state of having shrunk more than in the case where there is no base layer 101.

In this state, when the base layer 101 and the oxide film 102 in the center region of the lower surface of the SOI wafer 100 are removed, the oxide film 102 of the rib portion 42 is released from the compressive stress and expands in the horizontal direction, as shown in FIG. 3B. Accordingly, the active layer 103 of the center portion 41 is lifted upward, so that bending occurs in the reflection surface 40a of the upper surface of the movable part 40 (the upper surface of the active layer 103).

Therefore, in Embodiment 1, the active layer 103 in a predetermined range of the outer peripheral region is removed from the SOI wafer 100 in the rib portion 42 of the movable part 40.

FIG. 4A to FIG. 4C are cross-sectional views showing a procedure for forming the movable part 40 according to Embodiment 1.

As shown in FIG. 4B, the active layer 103 in a predetermined range (outer peripheral region A1) of the outer peripheral region of the movable part 40 is removed by etching from the SOI wafer 100 shown in FIG. 4A. The SOI wafer 100 has a circular column shape, and the range of the active layer 103 removed by etching has a ring shape in a plan view. Subsequently, as shown in FIG. 4C, the base layer 101 and the oxide film 102 in the center region are removed by etching. The base layer 101 and the oxide film 102 removed by etching have a circular column shape. Accordingly, the center portion 41 composed only of the active layer 103 is formed in the center region of the movable part 40, and the rib portion 42 is formed in the outer peripheral region. Thus, the movable part 40 of Embodiment 1 is completed.

According to Embodiment 1, since the active layer 103 is removed from the outer peripheral region A1 of the rib portion 42, the area of an inner peripheral region A2 of the rib portion 42 where the active layer 103 extending from the center portion 41 and the oxide film 102 of the rib portion 42 are in contact with each other is narrower than in Comparative Example 1 shown in FIG. 3B. Accordingly, the expansion of the oxide film 102 is less likely to propagate to the active layer 103, so that bending is less likely to occur in the center portion 41.

FIG. 5A and FIG. 5B are respectively a plan view and a cross-sectional view schematically showing the configuration of the movable part 40 according to Embodiment 1.

In Embodiment 1, the active layer 103 is removed in a ring shape from the outer peripheral region A1 of the rib portion 42 in a plan view. In this case, the inner peripheral region A2 where the active layer 103 and the oxide film 102 are in contact with each other is a ring-shaped narrow range.

Each coupling beam 35 connected to the movable part 40 may have a layer structure composed of the base layer 101, the oxide film 102, and the active layer 103, may have a layer structure composed of the base layer 101 and the oxide film 102, or may be composed only of the base layer 101.

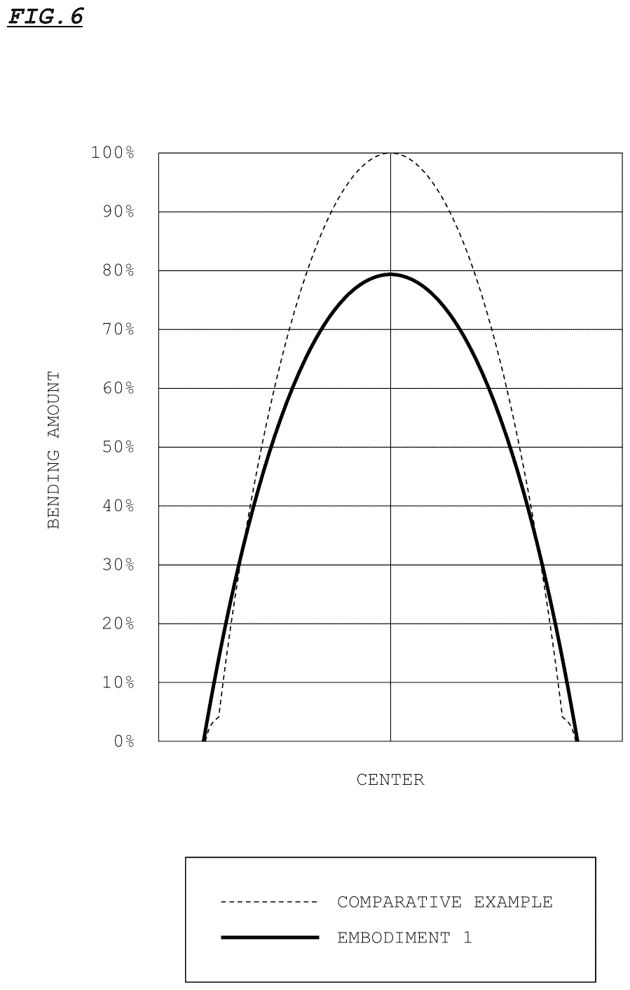

FIG. 6 is a graph showing simulation results for a bending amount according to Comparative Example 1 and Embodiment 1.

The inventors investigated, by simulation, the extent to which the active layer 103 of the movable part 40 bent in the configuration of Comparative Example 1 shown in FIG. 3A and FIG. 3B and the configuration of Embodiment 1 shown in FIG. 5A and FIG. 5B. In this simulation, only portions extending in the X-axis direction, of the pair of coupling beams 35 connected to the movable part 40, were left, and outer end portions of the pair of coupling beams 35 were set as fixed ends. In addition, in the simulation of Comparative Example 1, each coupling beam 35 was composed of the base layer 101, the oxide film 102, and the active layer 103, and in the simulation of Embodiment 1, each coupling beam 35 was composed of the base layer 101 and the oxide film 102.

In FIG. 6, the horizontal axis indicates the distance in the horizontal direction from the center C10, and the vertical axis indicates the bending amount of the center portion 41. The bending amount is a value normalized with the bending amount of the center C10 in Comparative Example 1 as 100%.

As shown in FIG. 6, in Embodiment 1, the bending amount around the center C10 was reduced to about 80% of that in Comparative Example 1. From this, it was found that with the configuration of Embodiment 1, bending that occurs in the center portion 41 can be suppressed.

### Effects of Embodiment 1

According to Embodiment 1, the following effects are achieved.

As shown in FIG. 5A and FIG. 5B, the center portion 41 of the movable part 40 has a structure in which the base layer 101 and the oxide film 102 are removed from the SOI wafer 100 in which the base layer 101, the oxide film 102, and the active layer 103 are stacked. The rib portion 42 has a structure in which at least a part of the active layer 103 is removed from the SOI wafer 100.

In the production of the SOI wafer 100, the base layer 101 is thermally oxidized at about 1100° C. to form the oxide film 102 on the surface of the base layer 101, and the active layer 103 is then bonded to the oxide film 102. The base layer 101 has a higher thermal expansion coefficient than the oxide film 102, and when the base layer 101 returns to room temperature, the base layer 101 attempts to shrink more than the oxide film 102. Thus, at this time, compressive stress is applied from the base layer 101 to the oxide film 102. When such an SOI wafer 100 is processed to remove the base layer 101 and the oxide film 102 from the center region of the movable part 40 and form the rib portion 42 in the outer peripheral region, the above compressive stress applied to the oxide film 102 of the rib portion 42 is partially released due to the removal of the base layer 101 in the center region as shown in Comparative Example 1 in FIG. 3A and FIG. 3B, so that the oxide film 102 expands. Accordingly, a force is applied from the oxide film 102 to the active layer 103 of the center portion 41 in a direction toward the center C10 of the center portion 41, so that bending occurs in the active layer 103 of the center portion 41. In contrast, according to Embodiment 1, since at least a part of the active layer 103 is removed in the rib portion 42 as shown in FIG. 5A and FIG. 5B, the expansion of the oxide film 102 is less likely to propagate to the active layer 103, so that bending is less likely to occur in the active layer 103 of the center portion 41. Therefore, when forming the rib portion 42 in the movable part 40 using the SOI wafer 100, bending of the movable part 40 can be suppressed.

The rib portion 42 has a structure in which the active layer 103 having a predetermined width (the active layer 103 in the outer peripheral region A1) is removed from the SOI wafer 100 along the circumferential direction of the movable part 40. With this confirmation, the expansion of the oxide film 102 of the rib portion 42 is less likely to be transmitted to the active layer 103 of the center portion 41 evenly over the entire circumference, so that bending of the center portion 41 can be suppressed evenly over the entire circumference.

### Modification 1 of Embodiment 1

In Embodiment 1, the entirety of the active layer 103 is removed in the outer peripheral region A1 of the rib portion 42, but a part of the active layer 103 may be left.

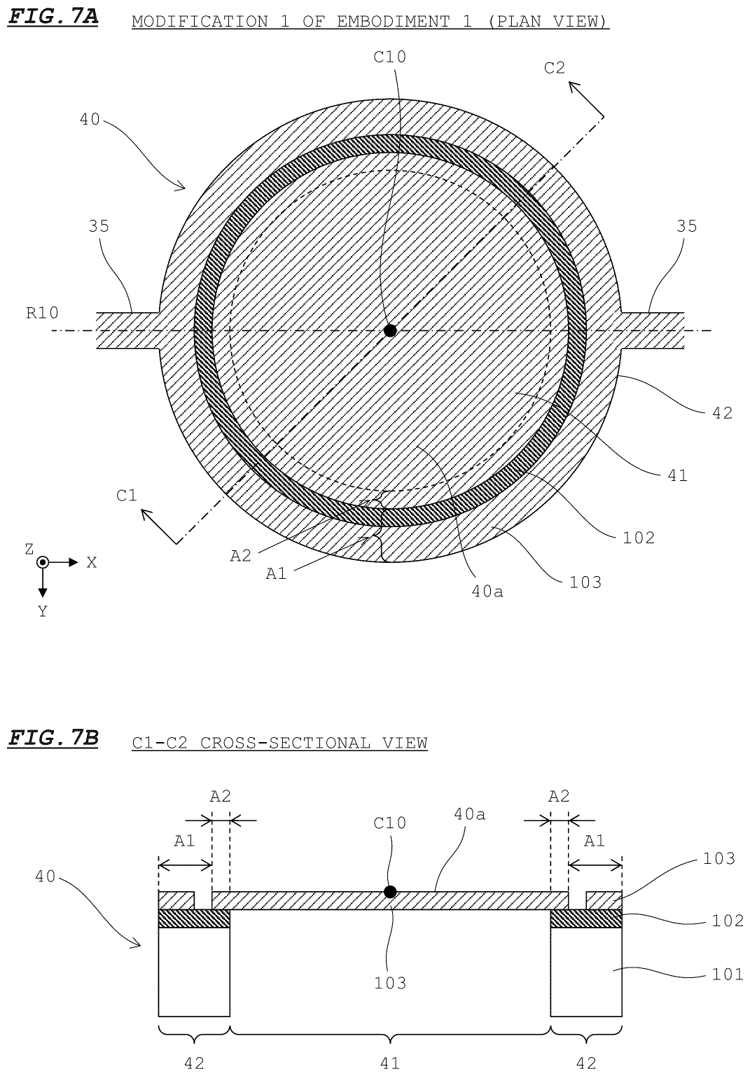

FIG. 7A and FIG. 7B are respectively a plan view and a cross-sectional view schematically showing a configuration of a movable part 40 according to this modification.

In this modification, compared to Embodiment 1 shown in FIG. 5A and FIG. 5B, the active layer 103 is left in a ring shape in a plan view at the outer periphery of the outer peripheral region A1 of the rib portion 42. A gap having a predetermined width is formed between the active layer 103 formed at the outer periphery of the rib portion 42 and the active layer 103 extending from the center portion 41.

In this modification as well, since the inner peripheral region A2 where the active layer 103 extending from the center portion 41 is in contact with the oxide film 102 is narrow, the expansion of the oxide film 102 is less likely to propagate to the active layer 103, so that bending is less likely to occur in the center portion 41.

In addition, in this modification, since the active layer 103 is left at the outer periphery of the outer peripheral region A1 of the rib portion 42, the strength (hardness) of the rib portion 42 is higher than in Embodiment 1. Accordingly, the movable part 40 is less likely to be affected by displacement thereof from the coupling beams 35, so that bending of the movable part 40 can be further suppressed.

### Modification 2 of Embodiment 1

In Embodiment 1, in the outer peripheral region A1 of the rib portion 4, the entirety of the oxide film 102 is left, but the entirety of the oxide film 102 may be removed.

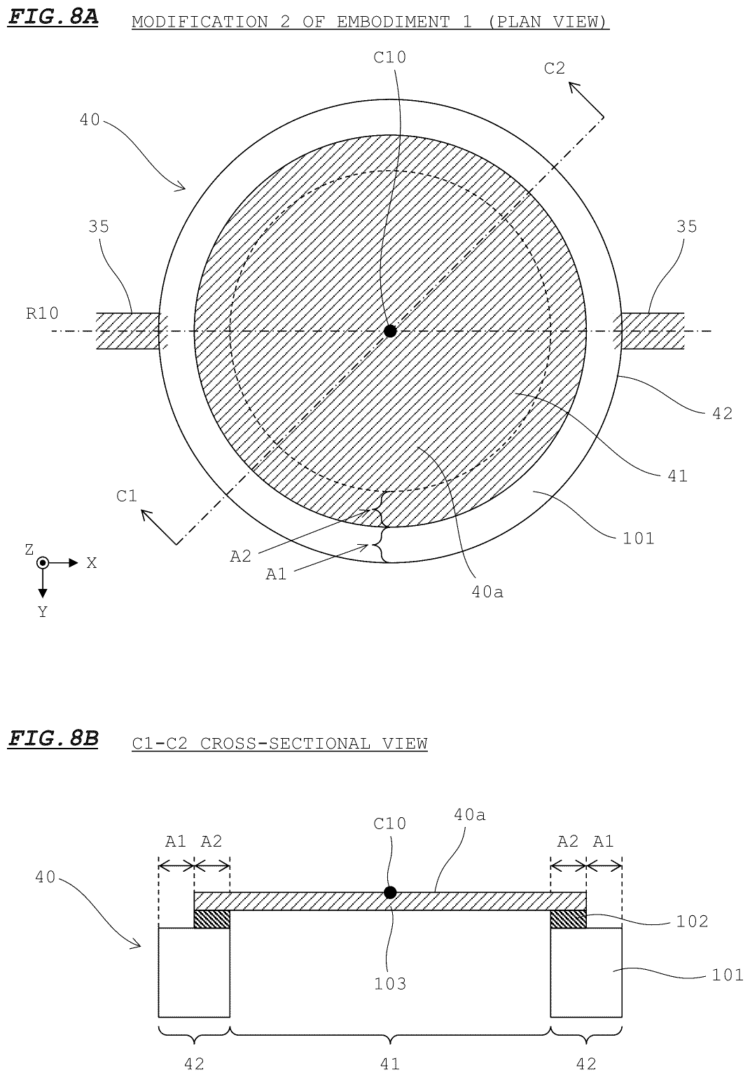

FIG. 8A and FIG. 8B are respectively a plan view and a cross-sectional view schematically showing a configuration of a movable part 40 according to this modification.

In this modification, compared to Embodiment 1 shown in FIG. 5A and FIG. 5B, not only the active layer 103 but also the oxide film 102 is removed from the outer peripheral region A1 of the rib portion 42.

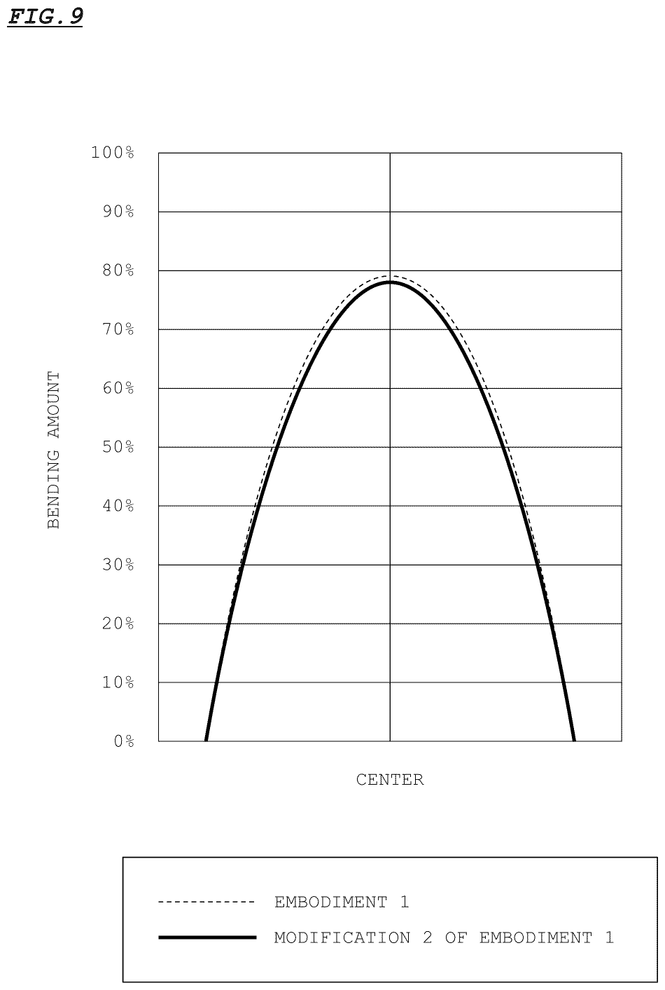

FIG. 9 is a graph showing simulation results for a bending amount according to Embodiment 1 and Modification 2 of Embodiment 1.

The inventors further investigated, by simulation, the extent to which the active layer 103 of the movable part 40 bent in the configuration of Modification 2 of Embodiment 1 shown in FIG. 8A and FIG. 8B under the same conditions as in the simulation described with reference to FIG. 6. In the simulation of Modification 2 of Embodiment 1, each coupling beam 35 was composed of the base layer 101. A broken line indicates the result of Embodiment 1, and a solid line indicates the result of Modification 2 of Embodiment 1. The bending amount is a value normalized with the bending amount of the center C10 in Comparative Example 1 shown in FIG. 3A and FIG. 3B as 100%. As shown in FIG. 9, in this modification, the bending amount around the center C10 was slightly reduced compared to Embodiment 1. From this, it was found that with the configuration of this modification, bending that occurs in the center portion 41 can be further suppressed.

According to Modification 2 of Embodiment 1, the rib portion 42 has a structure in which at least a part of the oxide film 102 is further removed from the SOI wafer 100, compared to Embodiment 1. With this configuration, the volume of the oxide film 102, which is the source of bending, is decreased, so that displacement of the oxide film 102 due to the expansion thereof is further decreased. Accordingly, bending of the center portion 41 can be further suppressed.

### Modification 3 of Embodiment 1

In Modification 2 of Embodiment 1, in the outer peripheral region A1 of the rib portion 42, the entirety of the oxide film 102 and the entirety of the active layer 103 are removed, but a part of the oxide film 102 and a part of the active layer 103 may be left.

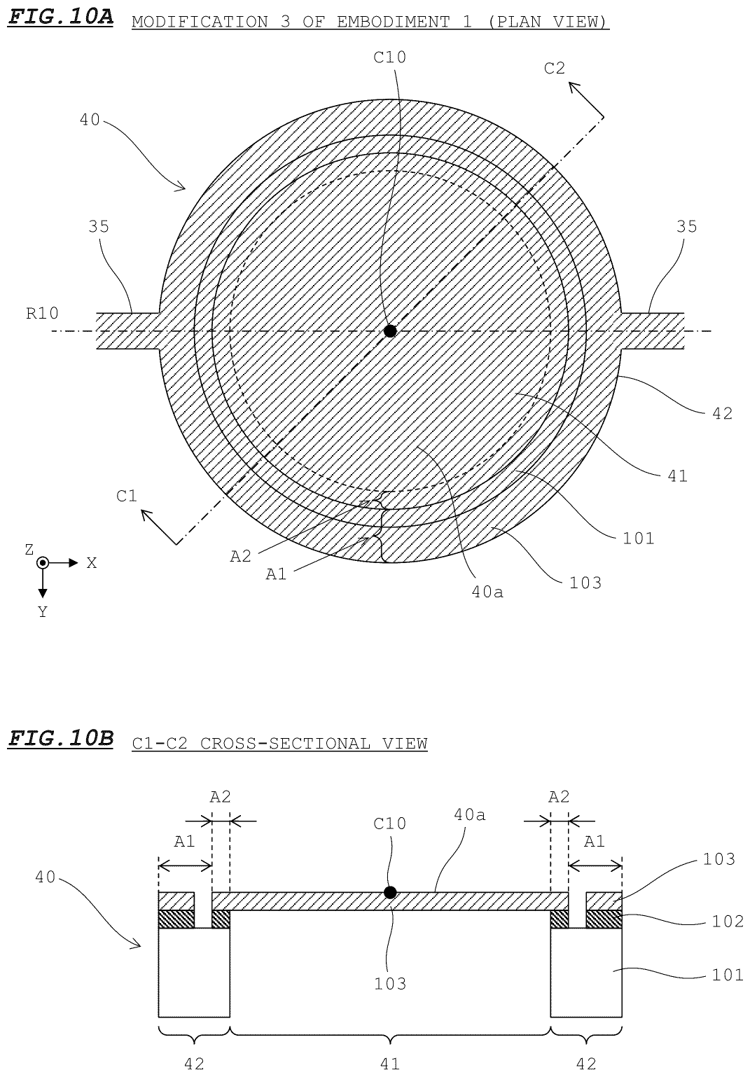

FIG. 10A and FIG. 10B are respectively a plan view and a cross-sectional view schematically showing a configuration of a movable part 40 according to this modification.

In this modification, compared to Modification 2 of Embodiment 1 shown in FIG. 8A and FIG. 8B, the oxide film 102 and the active layer 103 having a ring shape in a plan view are left at the outer periphery of the outer peripheral region A1 of the rib portion 42. A gap having a predetermined width is formed between the oxide film 102 and the active layer 103 formed at the outer periphery of the rib portion 42 and the active layer 103 extending from the center portion 41. The oxide film 102 and the active layer 103 formed at the outer periphery of the rib portion 42 have the same ring shape in a plan view.

In this modification as well, the volume of the oxide film 102, which is the source of bending, is decreased, so that displacement of the oxide film 102 due to the expansion thereof is further decreased. Accordingly, bending of the center portion 41 can be further suppressed. In addition, since the oxide film 102 and the active layer 103 are left at the outer periphery of the outer peripheral region A1 of the rib portion 42, the strength (hardness) of the rib portion 42 is increased. Accordingly, the movable part 40 is less likely to be affected by displacement thereof from the coupling beams 35, so that bending of the movable part 40 can be further suppressed.

### Embodiment 2

In Embodiment 2, a gap is provided between the center portion 41 and the rib portion 42 in a plan view, and the center portion 41 and the rib portion 42 are connected via a spring portion 43.

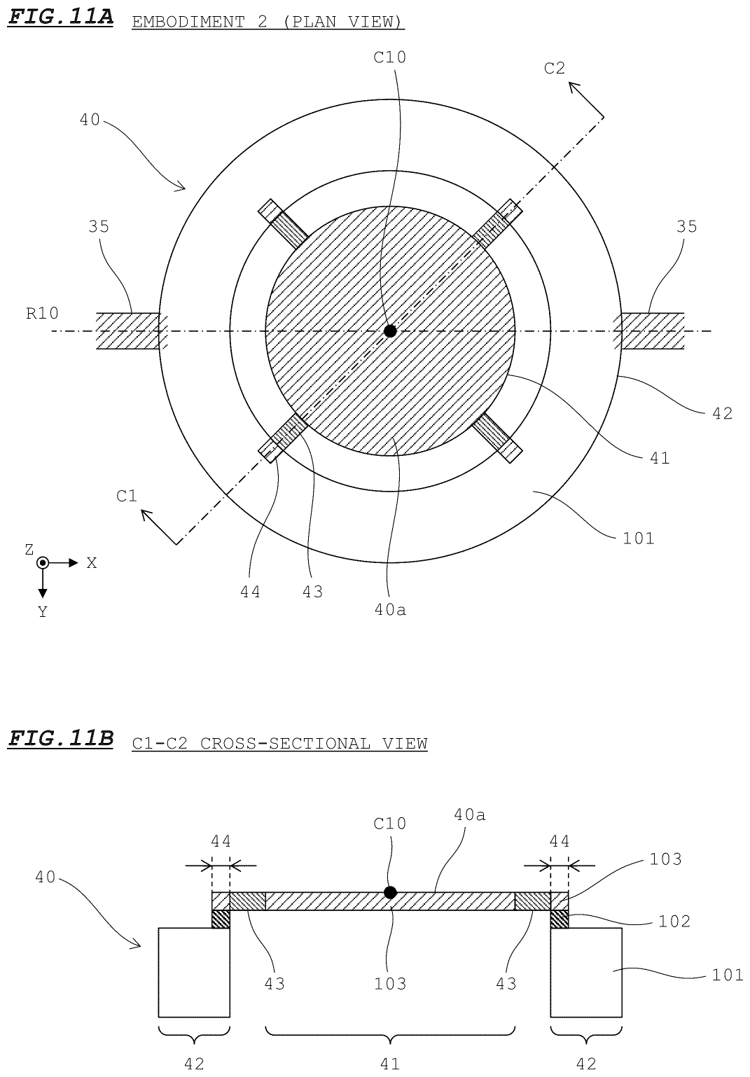

FIG. 11A and FIG. 11B are respectively a plan view and a cross-sectional view schematically showing a configuration of a movable part 40 according to Embodiment 2.

In Embodiment 2, compared to Embodiment 1 shown in FIG. 5A and FIG. 5B, the diameter of the center portion 41 is smaller than the diameter of the inner periphery of the rib portion 42, and the center portion 41 is positioned inside the inner periphery of the rib portion 42 in a plan view. The center portion 41 and the rib portion 42 are connected by four spring portions 43 that have flexibility. Each spring portion 43 is made of a shape and material that are easy to bend.

One end of each spring portion 43 is connected to an outer peripheral portion of the center portion 41, and the other end of each spring portion 43 is connected to the active layer 103 on the oxide film 102 left on the rib portion 42. The oxide film 102 and the active layer 103 on the rib portion 42 have shapes that are the same as each other in a plan view, and are placed only in the vicinity of an outer end portion of each spring portion 43. The oxide film 102 and the active layer 103 for connecting the spring portion 43 to the rib portion 42 form a connection portion 44. The connection portion 44 is provided at four locations on an inner peripheral portion of the rib portion 42. Four sets of the spring portions 43 and the four connection parts 44 are arranged at equal angles (90°) in the circumferential direction around the center C10.

Each spring portion 43 is typically made of the same material as the material connected to both ends of the spring portion 43. That is, each spring portion 43 is made of silicon (Si), which is the same as the center portion 41 (active layer 103) located on the inner side and the material (active layer 103) on the upper surface side of the connection portion 44 located on the outer side. In this case, each spring portion 43, the active layer 103 of the center portion 41, and the active layer 103 of the connection portion 44 are integrally formed.

Each spring portion 43 may be made of a material (a metal, a resin, etc.) other than silicon (Si). In this case, in the manufacturing process of the movable part 40, after a gap is formed between the active layer 103 of the center portion 41 and the active layer 103 of the connection portion 44, the spring portions 43 are formed, and the base layer 101 and the oxide film 102 are then removed from the center region.

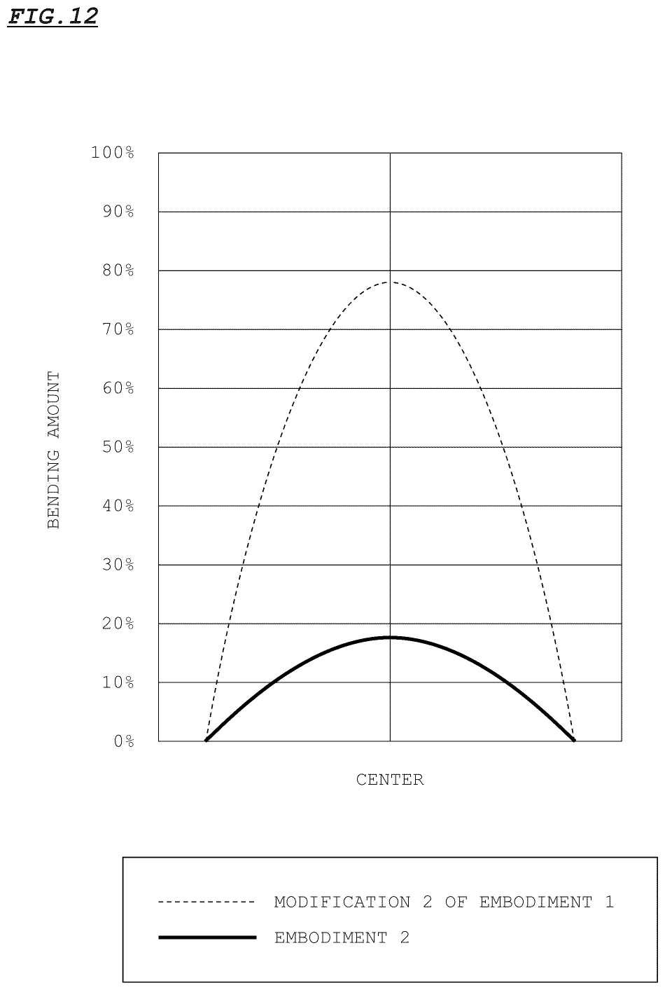

FIG. 12 is a graph showing simulation results for a bending amount according to Modification 2 of Embodiment 1 and Embodiment 2.

The inventors further investigated, by simulation, the extent to which the active layer 103 of the movable part 40 bended in the configuration of Embodiment 2 shown in FIG. 11A and FIG. 11B under the same conditions as in the simulation described with reference to FIG. 6. In the simulation of Embodiment 2, each coupling beam 35 was composed of the base layer 101. A broken line indicates the result of Modification 2 of Embodiment 1, and a solid line indicates the result of Embodiment 2. The bending amount is a value normalized with the bending amount of the center C10 in Comparative Example 1 shown in FIG. 3A and FIG. 3B as 100%.

As shown in FIG. 12, in Embodiment 2, the bending amount around the center C10 was significantly reduced compared to Modification 2 of Embodiment 1. From this, it was found that with the configuration of Embodiment 2, bending that occurs in the center portion 41 can be further suppressed.

### Effects of Embodiment 2

The center portion 41 and the rib portion 42 are connected via the flexible spring portions 43. With this configuration, compared to Embodiment 1 and the modification, the expansion of the oxide film 102 of the rib portion 42 is further less likely to be transmitted to the active layer 103 of the center portion 41, so that bending of the center portion 41 can be further suppressed.

The rib portion 42 has a configuration in which the oxide film 102 and the active layer 103 in a region other than regions (connection portions 44) connected to the spring portion 43 are removed from the SOI wafer 100. In this configuration, the oxide film 102 and the active layer 103 required to connect each spring portion 43 to the connection portion 44 are left, and the entirety of the oxide film 102 and the entirety of the active layer 103 are removed from the rib portion 42. Accordingly, since the oxide film 102 of the rib portion 42, which is the source of bending, is almost completely eliminated, bending of the center portion 41 can be further suppressed.

Each spring portion 43 is made of the same material as the center portion 41. With this configuration, the spring portions 43 and the center portion 41 can be formed at the same time, so that the manufacturing process of the optical reflection element 1 is simplified.

### Modifications of Embodiment 2

In Embodiment 2, the entirety of the oxide film 102 and the entirety of the active layer 103 are removed in the outer peripheral region located outside the connection portion 44, but if at least a part of the active layer 103 is removed in this outer peripheral region as in Embodiment 1 and Modifications 1 and 3 of Embodiment 1, the oxide film 102 and the active layer 103 may be left.

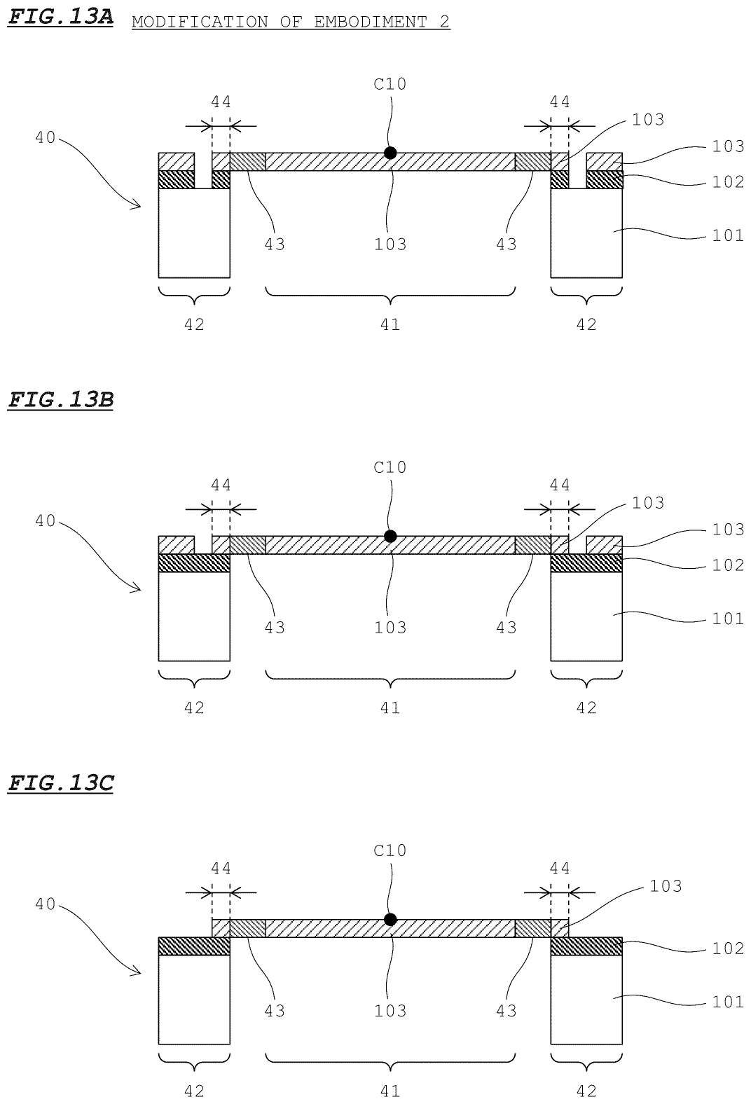

In a modification shown in FIG. 13A, compared to Embodiment 2, the oxide film 102 and the active layer 103 are left at the outer periphery of the rib portion 42 as in Modification 3 of Embodiment 1 shown in FIG. 10A and FIG. 10B. The oxide film 102 and the active layer 103 at the outer periphery of the rib portion 42 are placed with a gap with respect to the oxide film 102 and the active layer 103 of each connection portion 44.

In a modification shown in FIG. 13B, compared to Embodiment 2, the entirety of the oxide film 102 of the rib portion 42 is left, and a part of the active layer 103 of the rib portion 42 is left, as in Modification 1 of Embodiment 1 shown in FIG. 7A and FIG. 7B. The active layer 103 at the outer periphery of the rib portion 42 is placed with a gap with respect to the active layer 103 of each connection portion 44.

In a modification shown in FIG. 13C, compared to Embodiment 2, the entirety of the oxide film 102 of the rib portion 42 is left.

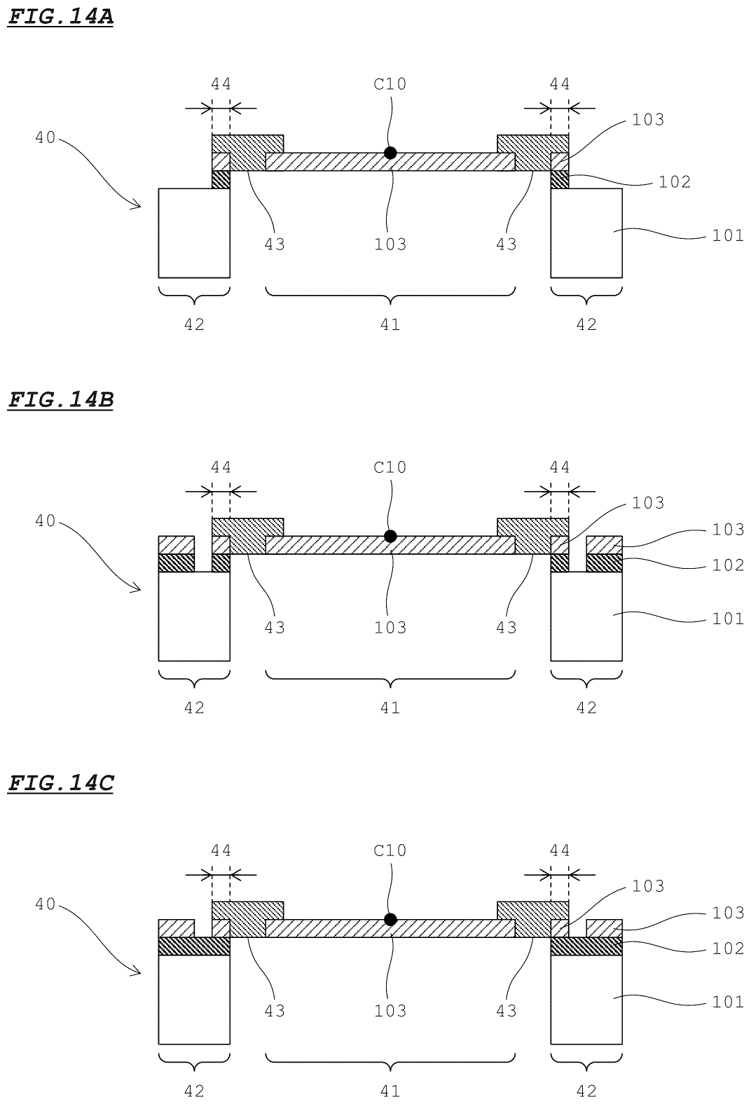

In a modification shown in FIG. 14A, compared to Embodiment 2, each spring portion 43 is made of a material (e.g., a metal, a resin, etc.) different from that of the center portion 41, and is placed so as to be located on the upper surface of the center portion 41 and the upper surface of the active layer 103 of the connection portion 44. In the case where each spring portion 43 is made of a material different from that of the center portion 41, when both ends of each spring portion 43 are arranged so as to be located on the active layers 103 of the center portion 41 and the connection portion 44, respectively, as shown in 14A, the center portion 41 and the connection portion 44 can be firmly connected.

In a modification shown in FIG. 14B, compared to the modification in FIG. 14A, the oxide film 102 and the active layer 103 are placed at the outer periphery of the rib portion 42 with a gap with respect to each connection portion 44 as in the modification in FIG. 13A.

In a modification shown in FIG. 14C, compared to the modification in FIG. 14B, the entirety of the oxide film 102 of the rib portion 42 is left as in the modification in FIG. 13B. In the configuration of FIG. 14C, the active layer 103 at the outer periphery of the rib portion 42 may be further removed.

In Embodiment 2, each spring portion 43 has a rectangular shape in a plan view, but the shape of the spring portion 43 is not limited to this shape.

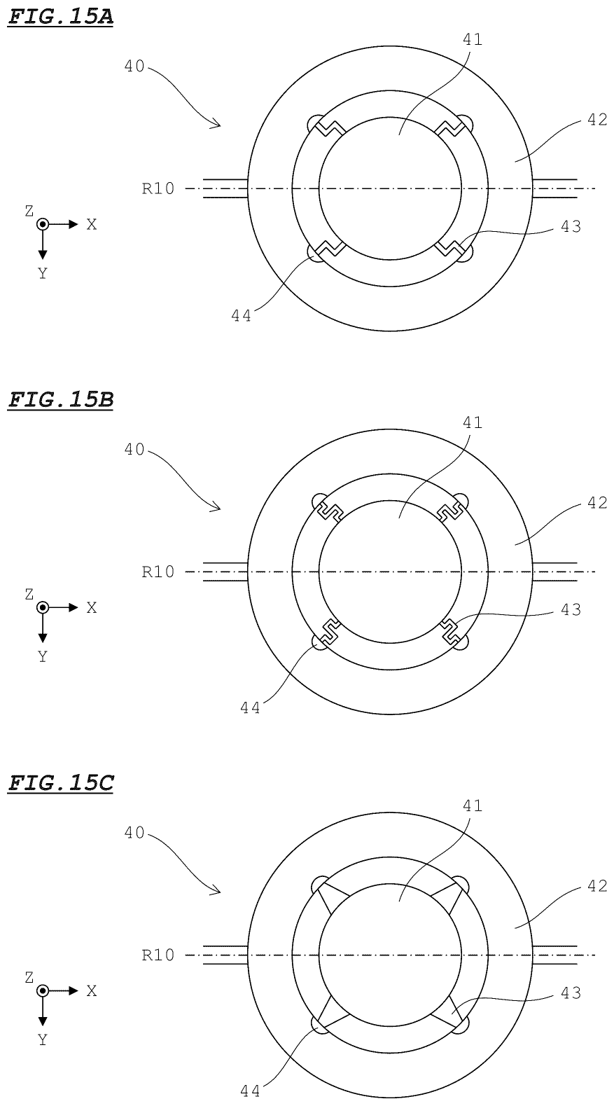

In modifications shown in FIG. 15A and FIG. 15B, each spring portion 43 has a meandering shape (meander shape). Accordingly, compared to Embodiment 2, the ease of bending of the spring portion 43 is further improved, so that the expansion of the oxide film 102 of the rib portion 42 is further less likely to be transmitted to the active layer 103 of the center portion 41.

In a modification shown in FIG. 15C, each spring portion 43 has a trapezoidal shape. By adjusting the trapezoidal shape, the ease of bending of the spring portion 43 or the difficulty of bending of the spring portion 43 can be smoothly adjusted. The shape of each spring portion 43 is not limited to the trapezoidal shape. For example, the shape of each spring portion 43 may be a parallelogram shape, a hexagonal shape, or the like.

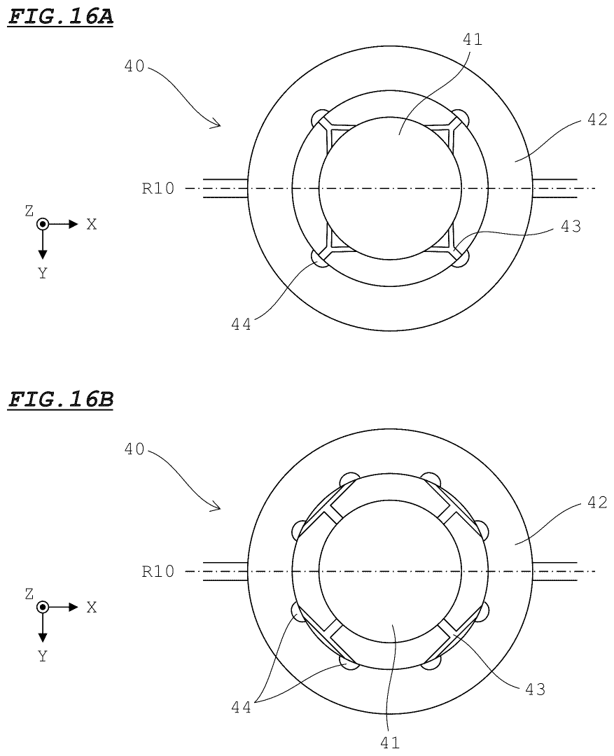

In a modification shown in FIG. 16A, each spring portion 43 has a Y-shape. In a modification shown in FIG. 16B, each spring portion 43 has a T-shape. In these cases as well, each spring portion 43 can be smoothly adjusted to the desired ease of bending.

In addition, in Embodiment 2, the end portion on the rib portion 42 side of each spring portion 43 may be configured in a planar shape.

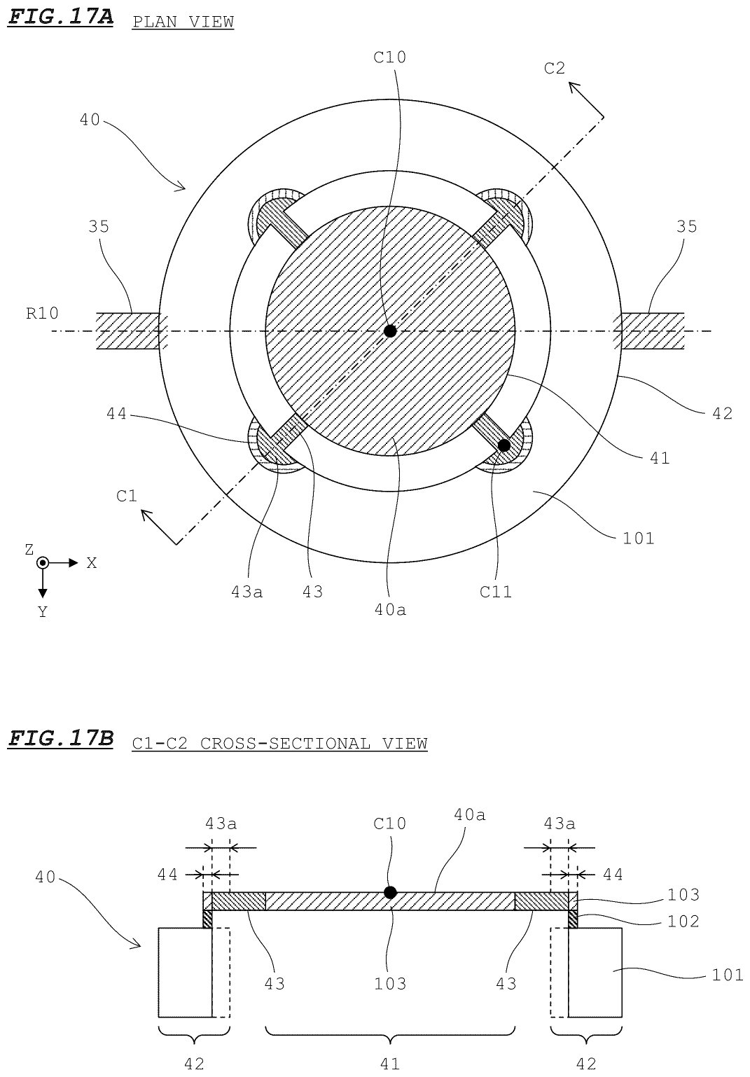

FIG. 17A and FIG. 17B are respectively a plan view and a cross-sectional view schematically showing a configuration of a movable part 40 according to a modification in this case.

In the modification in this case, a surface portion 43a is formed in the outer end portion of each spring portion 43. The surface portion 43a has a shape that spreads in the circumferential direction. In a plan view, the outer contour of the surface portion 43a has, for example, a circular shape centered at a point C11 at which a direction in which the spring portion 43 extends intersects the inner periphery of the rib portion 42. Each connection portion 44 (the oxide film 102 and the active layer 103) is placed at a position along the outer contour of the surface portion 43a, and the outer side of the surface portion 43a is connected to the active layer 103 of the connection portion 44.

In the modification shown in FIG. 17A and FIG. 17B, even if each spring portion 43 bends, stress is dispersed in the radial direction of the circle centered at the point C11, so that the outer end portion of each spring portion 43 and each connection portion 44 of the rib portion 42 can be prevented from being destroyed.

### Embodiment 3

In Embodiment 2, the outer end portion of each spring portion 43 is connected to the inner peripheral portion of the rib portion 42. In contrast, in Embodiment 3, the outer end portion of each spring portion 43 is positioned further outward than in Embodiment 2 and is connected to a cutout 42a formed at the inner periphery of the rib portion 42.

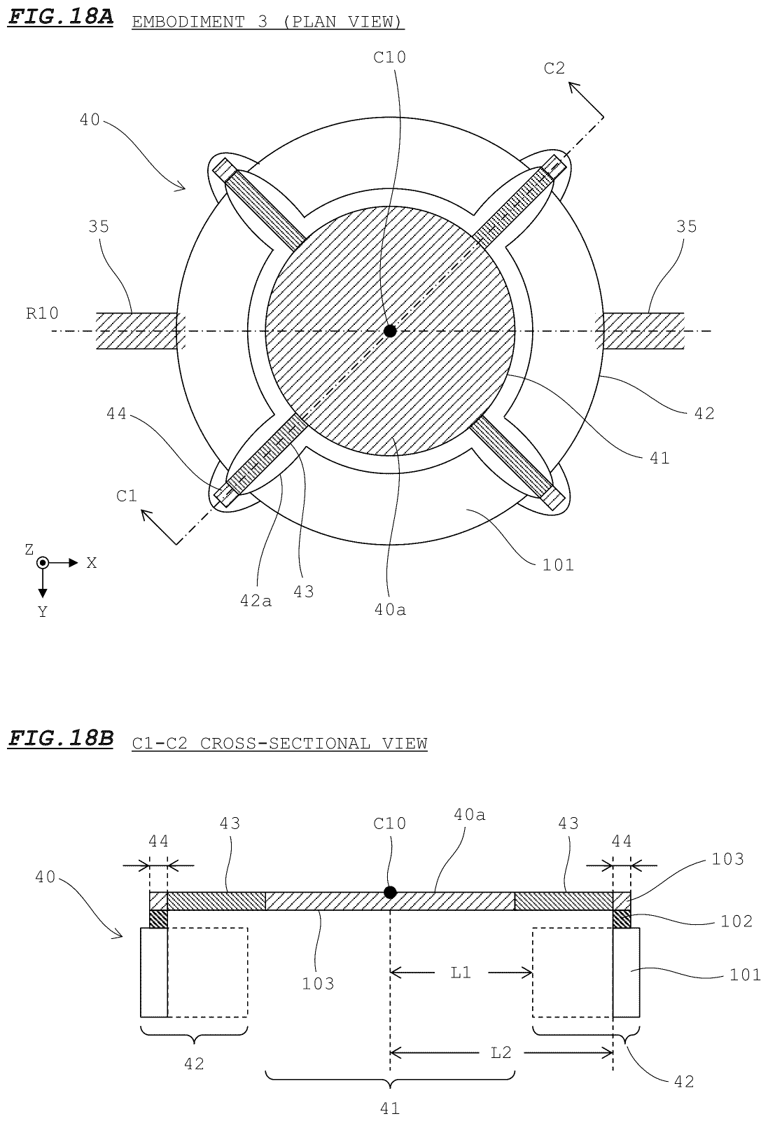

FIG. 18A and FIG. 18B are respectively a plan view and a cross-sectional view schematically showing a configuration of a movable part 40 according to Embodiment 3.

In Embodiment 3, compared to Embodiment 2 shown in FIG. 11A and FIG. 11B, at the inner periphery of the rib portion 42, the cutout 42a extending outward is formed at the position at which each spring portion 43 is placed. On the outer side of the cutout 42a, the outer periphery of the rib portion 42 protrudes outward. The width in the circumferential direction of the cutout 42a is larger than the width in the circumferential direction of the spring portion 43, and the spring portion 43 is housed in the cutout 42a. The outer end portion of the spring portion 43 is connected to the active layer 103 of the connection portion 44 located on the outer side of the cutout 42a. Accordingly, the outer end portion of the spring portion 43 is connected to the rib portion 42 on the outer side with respect to the inner periphery of the rib portion 42.

### Effects of Embodiment 3

As shown in FIG. 18B, a distance L1 from the center C10 of the center portion 41 to the inner periphery of the rib portion 42 is shorter than a distance L2 from the center C10 of the center portion 41 to the position at which the spring portion 43 and the rib portion 42 are connected. With this configuration, the rib portion 42 can be placed closer to the center portion 41 while the width in the radial direction of the rib portion 42 is kept constant. Thus, compared to Embodiment 2, the weight of the rib portion 42 can be decreased. Accordingly, a decrease in the driving efficiency of the movable part 40 can be suppressed.

### Modifications of Embodiment 3

In Embodiment 3, each spring portion 43 has a rectangular shape, but the shape of the spring portion 43 is not limited to this shape.

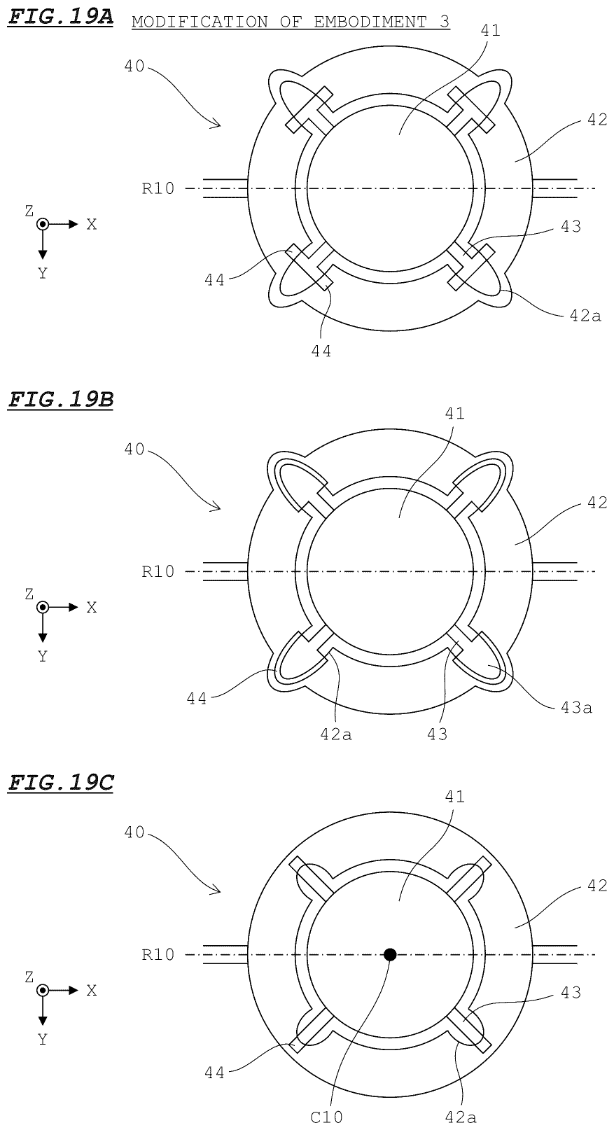

In a modification shown in FIG. 19A, each spring portion 43 has a T-shape. In this case, two outer end portions of the spring portion 43 are connected to the active layers 103 of two connection portions 44 arranged at the periphery of the cutout 42a so as to oppose each other.

In a modification shown in FIG. 19B, a surface portion 43a is formed in the outer end portion of each spring portion 43 as in the modification shown in FIG. 17A and FIG. 17B. The outer side of the surface portion 43a is connected to the active layer 103 of a connection portion 44 placed at the periphery of the cutout 42a.

In a modification shown in FIG. 19C, compared to Embodiment 3 shown in FIG. 18A and FIG. 18B, the position at which each spring portion 43 and the rib portion 42 are connected is closer to the center C10 of the center portion 41, and the outer periphery of the rib portion 42 has a circular shape. In this case, compared to Embodiment 3, the length of the spring portion 43 is shorter, so that the spring portion 43 becomes difficult to bend, but as in Embodiment 3, the rib portion 42 can be placed closer to the center portion 41.

### Modification 1 of Movable Part

It is preferable that, as in Embodiments 1 to 3 and the modifications described above, the movable part 40 is configured to be line-symmetrical with respect to a straight line R11 that passes through the center C10 of the center portion 41 and is perpendicular to the rotation axis R10. Accordingly, the weight balance of the movable part 40 across the straight line R11 can be made equal, so that the movable part 40 can be driven appropriately. Hereinafter, modifications of the movable part 40 configured to be line-symmetrical about the straight line R11 will be described with examples.

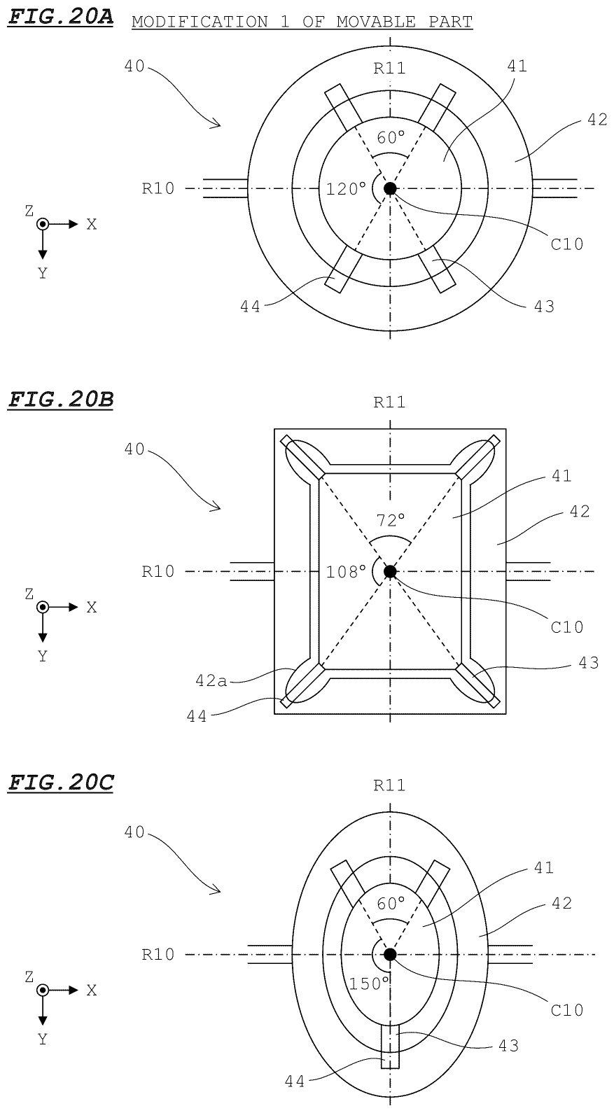

In a modification shown in FIG. 20A, compared to Embodiment 2 shown in FIG. 11A and FIG. 11B, four sets each consisting of a spring portion 43 and a connection portion 44 on the outer side of the spring portion 43 are arranged at intervals of 60° and 120° in the circumferential direction around the center C10.

In a modification shown in FIG. 20B, compared to Embodiment 3 shown in FIG. 18A and FIG. 18B, the center portion 41, the inner periphery of the rib portion 42, and the outer periphery of the rib portion 42 have a rectangular shape in a plan view. Cutouts 42a are respectively formed at the four corners of the inner periphery of the rib portion 42, and spring portions 43 are positioned at these cutouts 42a. Four sets each consisting of a spring portion 43 and a connection portion 44 on the outer side of the spring portion 43 are arranged at intervals of 72° and 108° in the circumferential direction around the center C10.

In a modification shown in FIG. 20C, compared to Embodiment 2 shown in FIG. 11A and FIG. 11B, the center portion 41, the inner periphery of the rib portion 42, and the outer periphery of the rib portion 42 have an elliptical shape in a plan view. Three sets each consisting of a spring portion 43 and a connection portion 44 on the outer side of the spring portion 43 are arranged at intervals of 60° and 150° in the circumferential direction around the center C10.

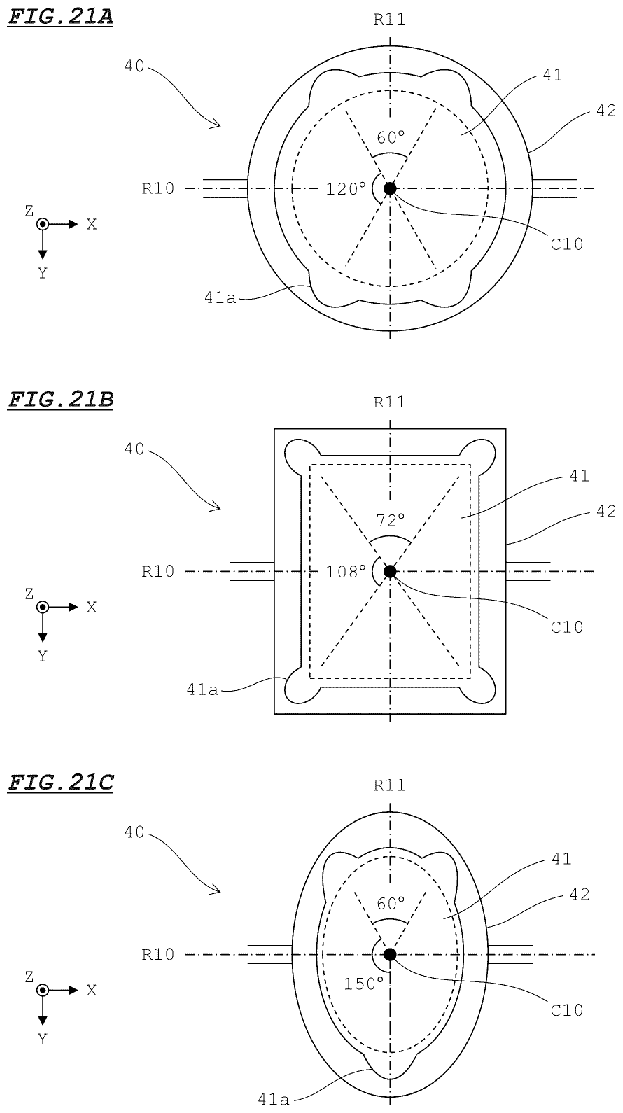

In a modification shown in FIG. 21A, compared to Embodiment 1 shown in FIG. 5A and FIG. 5B, four protrusions 41a protruding outward are formed at the outer periphery of the active layer 103 of the movable part 40. Below each protrusion 41a, an oxide film 102 and an active layer 103 that have the same shape as the shape of the protrusion 41a in a plan view are placed. The four protrusions 41a are arranged at intervals of 60° and 120° in the circumferential direction around the center C10.

In a modification shown in FIG. 21B, compared to the modification in FIG. 21A, the center portion 41, the inner periphery of the rib portion 42, and the outer periphery of the rib portion 42 have a rectangular shape in a plan view. Protrusions 41a are respectively formed at the four corners of the active layer 103 of the movable part 40. The four protrusions 41a are arranged at intervals of 72° and 108° in the circumferential direction around the center C10.

In a modification shown in FIG. 21C, compared to the modification in FIG. 21A, the center portion 41, the inner periphery of the rib portion 42, and the outer periphery of the rib portion 42 have an elliptical shape in a plan view. Three protrusions 41a are formed at the outer periphery of the active layer 103 of the movable part 40. The three protrusions 41a are arranged at intervals of 60° and 150° in the circumferential direction around the center C10.

In FIG. 20A to FIG. 20C, as long as the movable part 40 is line-symmetrical with respect to the straight line R11, a plurality of sets each consisting of a spring portion 43 and a connection portion 44 on the outer side of the spring portion 43 may be arranged at angles other than the above angles in the circumferential direction around the center C10. In addition, in FIG. 21A to FIG. 21C, as long as the movable part 40 is line-symmetrical with respect to the straight line R11, a plurality of protrusions 41a may be arranged at angles other than the above angles in the circumferential direction around the center C10.

In all of the modifications in FIG. 20A to FIG. 21C as well, the movable part 40 is configured to be line-symmetrical with respect to the straight line R11. With this configuration, the weight balance of the movable part 40 across the straight line R11 can be made equal. Thus, the movable part 40 can be driven appropriately.

### Modification 2 of Movable Part

It is preferable that, as in Embodiments 1 to 3 and the modifications described above, the movable part 40 is configured such that bending that occurs in the center portion 41 due to the expansion of the oxide film 102 is substantially symmetrical about a central axis that passes through the center C10 of the center portion 41 in the up-down direction (Z-axis direction). Accordingly, reflected light that is reflected by the center portion 41 is distributed substantially symmetrically with respect to the optical axis thereof, so that it becomes easier to design an optical system in the subsequent stage on which the reflected light is incident. Hereinafter, modifications of such a movable part 40 will be described with examples.

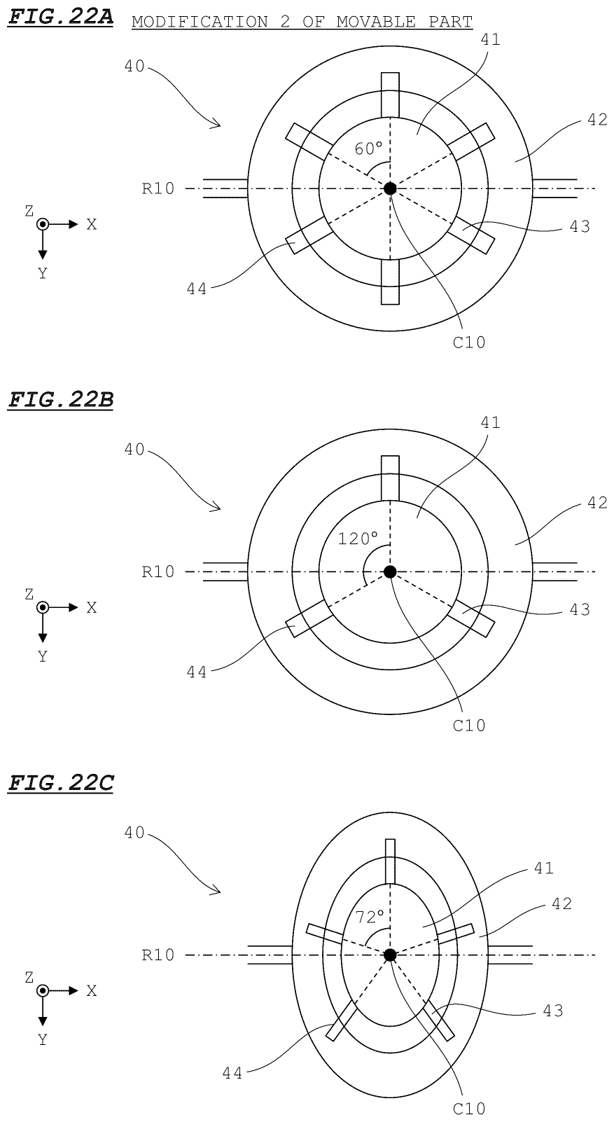

In a modification shown in FIG. 22A, compared to Embodiment 2 shown in FIG. 11A and FIG. 11B, six sets each consisting of a spring portion 43 and a connection portion 44 on the outer side of the spring portion 43 are arranged at equal intervals of 60° in the circumferential direction with respect to the center C10.

In a modification shown in FIG. 22B, compared to Embodiment 2, three sets each consisting of a spring portion 43 and a connection portion 44 on the outer side of the spring portion 43 are arranged at equal intervals of 120° in the circumferential direction around the center C10.

In a modification shown in FIG. 22C, compared to Embodiment 2, the center portion 41, the inner periphery of the rib portion 42, and the outer periphery of the rib portion 42 have an elliptical shape in a plan view, and five sets each consisting of a spring portion 43 and a connection portion 44 on the outer side of the spring portion 43 are arranged at equal intervals of 72° in the circumferential direction with respect to the circumferential direction.

When the respective sets are arranged in a polygonal shape at equal angles in the circumferential direction as described above, the length on the outer periphery of the center portion 41 and the length on the inner periphery of the rib portion 42 between two adjacent sets become substantially equal to each other. Accordingly, while strain of the center portion 41 is gradually suppressed as the distance to the center C10 of the center portion 41 decreases, deformation of the center portion 41 becomes substantially uniform about the central axis that passes through the center C10 in the up-down direction.

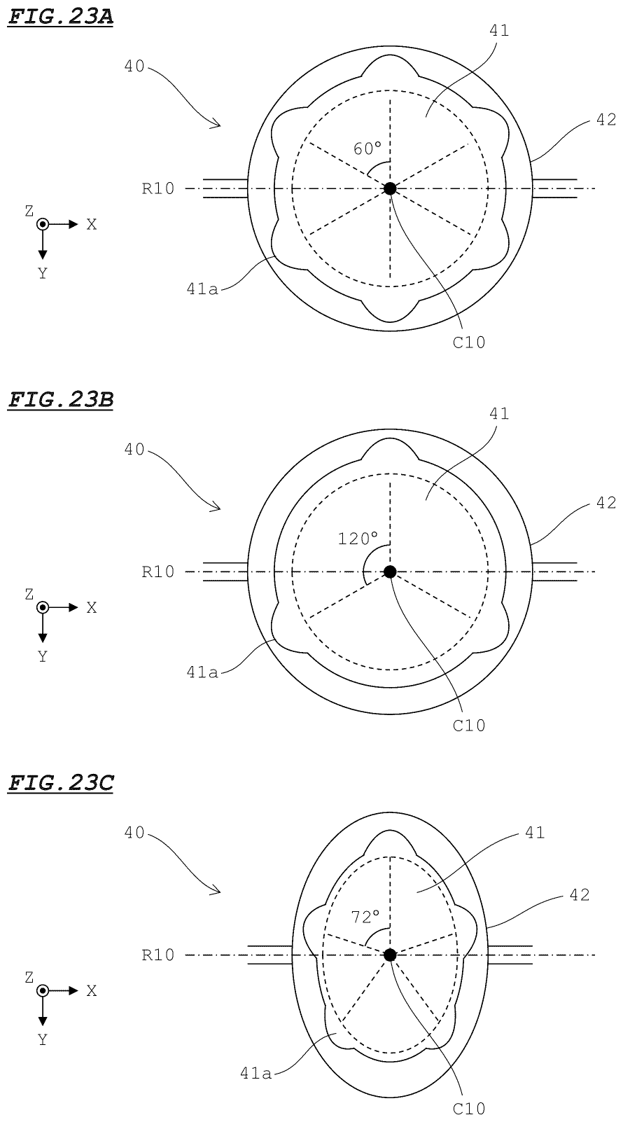

In a modification shown in FIG. 23A, compared to Embodiment 1 shown in FIG. 5A and FIG. 5B, six protrusions 41a protruding outward are formed at the outer periphery of the active layer 103 of the movable part 40. Below each protrusion 41a, an oxide film 102 and an active layer 103 that have the same shape as the shape of the protrusion 41a in a plan view are placed. The six protrusions 41a are arranged at equal intervals of 60° in the circumferential direction around the center C10.

In a modification shown in FIG. 23B, compared to the modification in FIG. 23A, three protrusions 41a protruding outward are formed at the outer periphery of the active layer 103 of the movable part 40. Three protrusions 41a are arranged at equal intervals of 120° in the circumferential direction around the center C10.

In a modification shown in FIG. 23C, compared to the modification in FIG. 23A, the center portion 41, the inner periphery of the rib portion 42, and the outer periphery of the rib portion 42 have an elliptical shape in a plan view, and five protrusions 41a protruding outward are formed at the outer periphery of the active layer 103 of the movable part 40. The five protrusions 41a are arranged at equal intervals of 72° in the circumferential direction around the center C10.

When the protrusions 41a are arranged in a polygonal shape at equal angles in the circumferential direction as described above, the length on the outer periphery of the center portion 41 between two adjacent protrusions 41a becomes substantially equal to each other. Accordingly, while strain of the center portion 41 is gradually suppressed as the distance to the center C10 of the center portion 41 decreases, deformation of the center portion 41 becomes substantially uniform about the central axis that passes through the center C10 in the up-down direction.

In FIG. 22A to FIG. 23C, the movable part 40 is configured such that bending that occurs in the center portion 41 due to the expansion of the oxide film 102 is substantially symmetrical about the central axis that passes through the center C10 of the center portion 41 in the up-down direction. With this configuration, reflected light that is reflected by the movable part 40 is distributed substantially symmetrically with respect to the optical axis thereof, so that it becomes easier to design an optical system in the subsequent stage on which the reflected light is incident. Specifically, if incident light that is incident on the movable part 40 has a shape that is substantially symmetrical with respect to the optical axis of the incident light (e.g., a circular shape or an elliptical shape), reflected light that is reflected by the movable part 40 also has a shape that is substantially symmetrical with respect to the optical axis of the reflected light (e.g., a circular shape or an elliptical shape). Accordingly, it becomes easier to design the optical system in the subsequent stage.

In addition, the configurations of the movable part 40 at positions with substantially equal angles in the circumferential direction with respect to the center C10 of the center portion 41, are substantially the same as each other. With this configuration, the movable part 40 can be easily configured such that bending that occurs in the center portion 41 is substantially symmetrical about the central axis of the center portion 41. In addition, as in the modifications in FIG. 22A and FIG. 22B and FIG. 23A and FIG. 23B, in the case where the movable part 40 has a circular shape, if incident light that is incident on the movable part 40 has a circular shape, reflected light that is reflected by the movable part 40 can be distributed substantially uniformly with respect to the optical axis of the reflected light.

Next, verification conducted for the distribution of reflected light by the inventors will be described. The inventors verified whether or not reflected light that was reflected by the center portion 41 is substantially symmetrical about the optical axis thereof, based on the bending amount of the center portion 41 obtained by simulation, using the configurations of Embodiment 2 and Comparative Example 2.

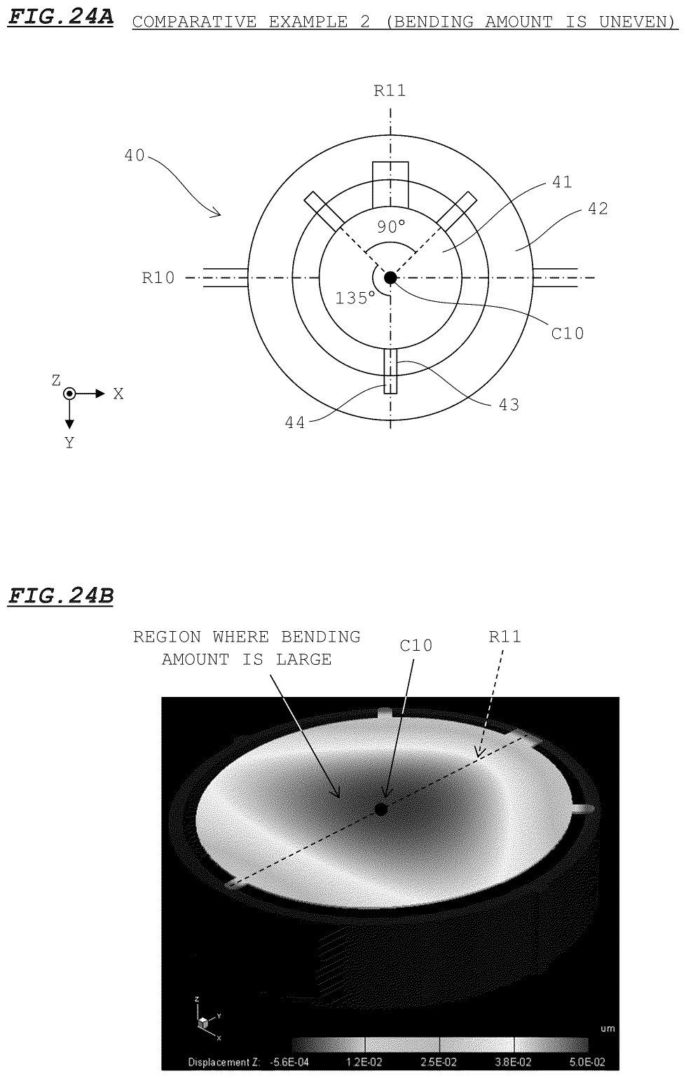

FIG. 24A is a plan view schematically showing a configuration of a movable part 40 according to simulation of Comparative Example 2. In Comparative Example 2, four sets of spring portions 43 and connection portions 44 are provided. Two sets of spring portions 43 and connection portions 44 are arranged in directions at 45° with respect to the rotation axis R10 and the straight line R11 and on the Y-axis negative side of the rotation axis R10. Two sets of spring portions 43 and connection portions 44 are arranged in a direction along the straight line R11 and on the Y-axis positive side and the Y-axis negative side of the rotation axis R10, respectively. In addition, the width of one set of a spring portion 43 and a connection portion 44 located on the Y-axis negative side of the center C10 is wider than the widths of the other sets of spring portions 43 and connection portions 44.

FIG. 24B shows a simulation result showing the bending amount of the center portion 41 during rotation of the movable part 40 according to Comparative Example 2. A dark-colored region at and near the center C10 indicates that bending is greater than in a light-colored region around the center portion 41. As shown in FIG. 24B, in Comparative Example 2, bending that occurs in the center portion 41 is not substantially symmetrical about the central axis that passes through the center C10 in the up-down direction.

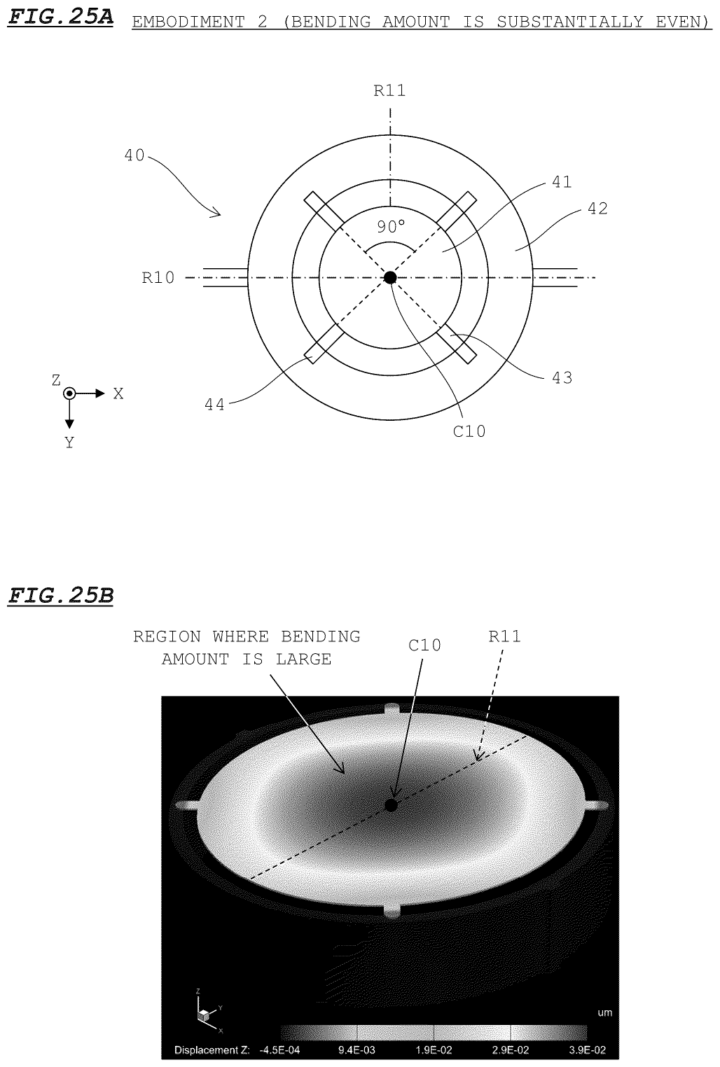

FIG. 25A is a plan view schematically showing a configuration of a movable part 40 according to simulation of Embodiment 2. In the configuration of Embodiment 2 shown in FIG. 25A, as in the configuration shown in FIG. 11A and FIG. 11B, four sets of spring portions 43 and connection portions 44 are arranged at equal angles (90°) in the circumferential direction around the center C10.

FIG. 25B shows a simulation result showing the bending amount of the center portion 41 during rotation of the movable part 40 according to Embodiment 2. A dark-colored region at and near the center C10 indicates that bending is greater than in a light-colored region around the center portion 41. As shown in FIG. 25B, in Embodiment 2, bending that occurs in the center portion 41 is substantially symmetrical about the central axis that passes through the center C10 in the up-down direction.

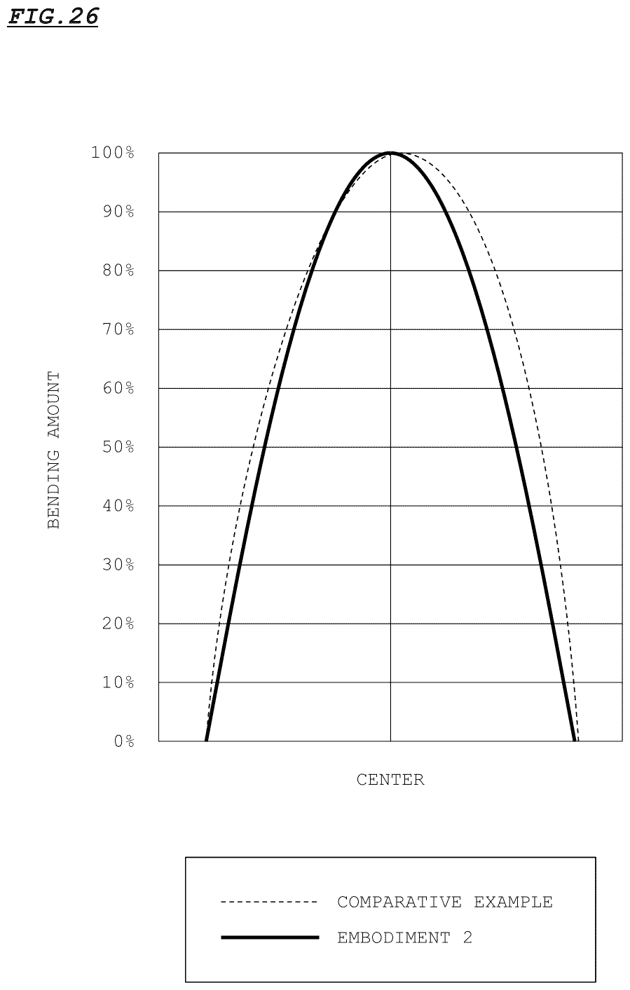

FIG. 26 is a graph showing simulation results for a bending amount according to Comparative Example 2 and Embodiment 2.

The inventors investigated, by simulation, the extent to which the active layer 103 of the movable part 40 bended in the configuration of Comparative Example 2 shown in FIG. 24A and the configuration of Embodiment 2 shown in FIG. 25A under the same conditions as in the simulation described with reference to FIG. 6. The horizontal axis indicates the distance along the straight line R11 from the center C10, and the vertical axis indicates the bending amount of the center portion 41. The bending amount is a value normalized with the maximum bending amount as 100% in each of Comparative Example 2 and Embodiment 2.

As shown by a broken line in FIG. 26, in Comparative Example 2, the bending amount is uneven on the left and right sides with respect to the center C10. When bending that occurs in the center portion 41 is uneven as described above, it is considered that if incident light that is incident on the center portion 41 is distributed substantially symmetrically with respect to the optical axis thereof, reflected light that is reflected by the center portion 41 is not distributed substantially symmetrically with respect to the optical axis thereof. In this case, the design of the optical system in the subsequent stage on which the reflected light is incident becomes complicated. In contrast, as shown by a solid line in FIG. 26, in Embodiment 2, the bending amount is substantially even on the left and right sides with respect to the center C10. When bending that occurs in the center portion 41 is substantially even as described above, it is considered that if incident light that is incident on the center portion 41 is distributed substantially symmetrically with respect to the optical axis thereof, reflected light that is reflected by the center portion 41 is distributed substantially symmetrically with respect to the optical axis thereof. In this case, it becomes easier to design the optical system in the subsequent stage on which the reflected light is incident.

In addition to the configuration of Embodiment 2, in the configurations of the modifications of Embodiment 2 shown in FIG. 13A to FIG. 17B, Embodiment 3 shown in FIG. 18A and FIG. 18B, the modifications of Embodiment 3 shown in FIG. 19A to FIG. 19C, and Modification 2 of the movable part 40 shown in FIG. 22A to FIG. 23C as well, the movable part 40 is configured such that bending that occurs in the center portion 41 due to the expansion of the oxide film 102 is substantially symmetrical about the central axis of the center portion 41. Therefore, in these configurations as well, the reflected light can be distributed substantially symmetrically with respect to the optical axis thereof, so that it becomes easier to design the optical system in the subsequent stage on which the reflected light is incident.

### <Modifications of Reflection Surface>

In the embodiments and the modifications described above, the upper surface of the active layer 103 of the movable part 40 is used as the reflection surface 40a, but the present invention is not limited thereto, and an optical reflection film 45 may be separately placed on the upper surface of the active layer 103, and the upper surface of the optical reflection film 45 may be used as the reflection surface 40a.

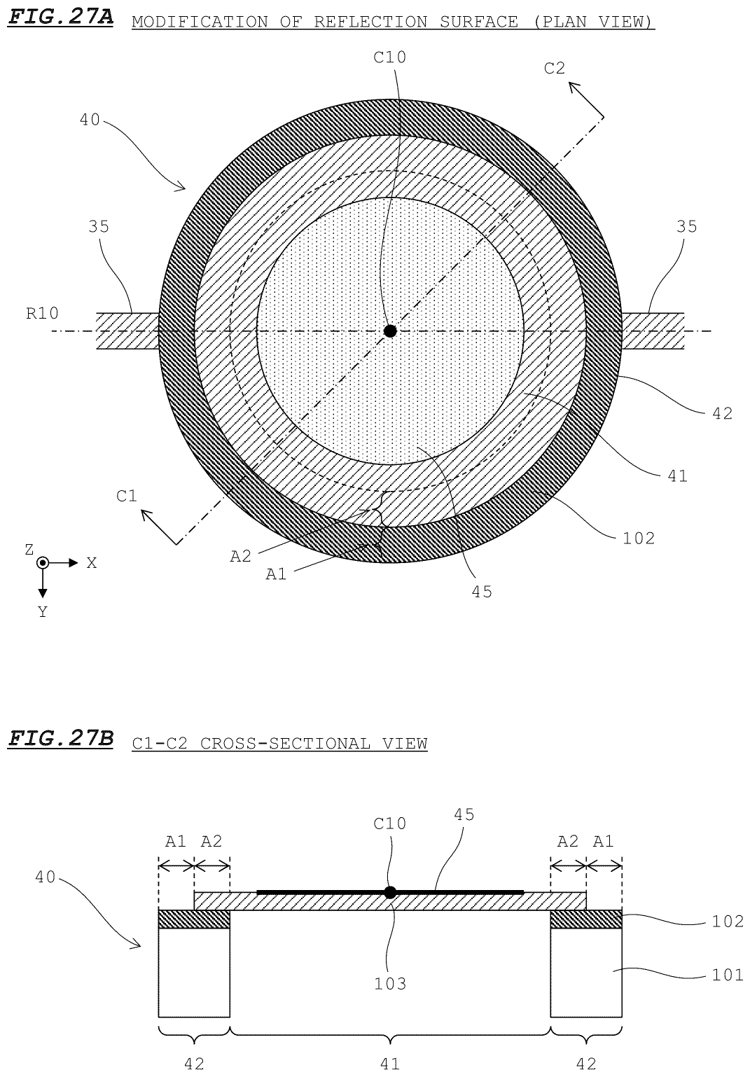

FIG. 27A and FIG. 27B are respectively a plan view and a cross-sectional view schematically showing a configuration of a movable part 40 according to this modification.

In this modification, compared to Embodiment 1 shown in FIG. 5A and FIG. 5B, the optical reflection film 45 is formed on the upper surface of the active layer 103 that forms the movable part 40. The optical reflection film 45 is formed on the upper surface of the active layer 103 from a material having a high reflectance (e.g., a metal or metal compound such as gold, silver, copper, or aluminum, silicon dioxide, titanium dioxide, or the like). The optical reflection film 45 may be composed of a dielectric multilayer film.

In FIG. 27A and FIG. 27B, the optical reflection film 45 is formed inside the center portion 41 in a plan view but may be formed in the same range as the center portion 41 or may be formed outside the center portion 41 as long as the optical reflection film 45 is within the range of the active layer 103.

In this modification, the optical reflection film 45 is further provided on the upper surface of the active layer 103. With this configuration, the reflectance can be improved compared to the case where the upper surface of the active layer 103 is used as the reflection surface 40a.

### <Modification of Vibration Parts>

In the embodiments and the modifications described above, the vibration parts 21 to 24 are arranged in a meander shape, but in this modification, vibration parts are arranged in a tuning fork shape.

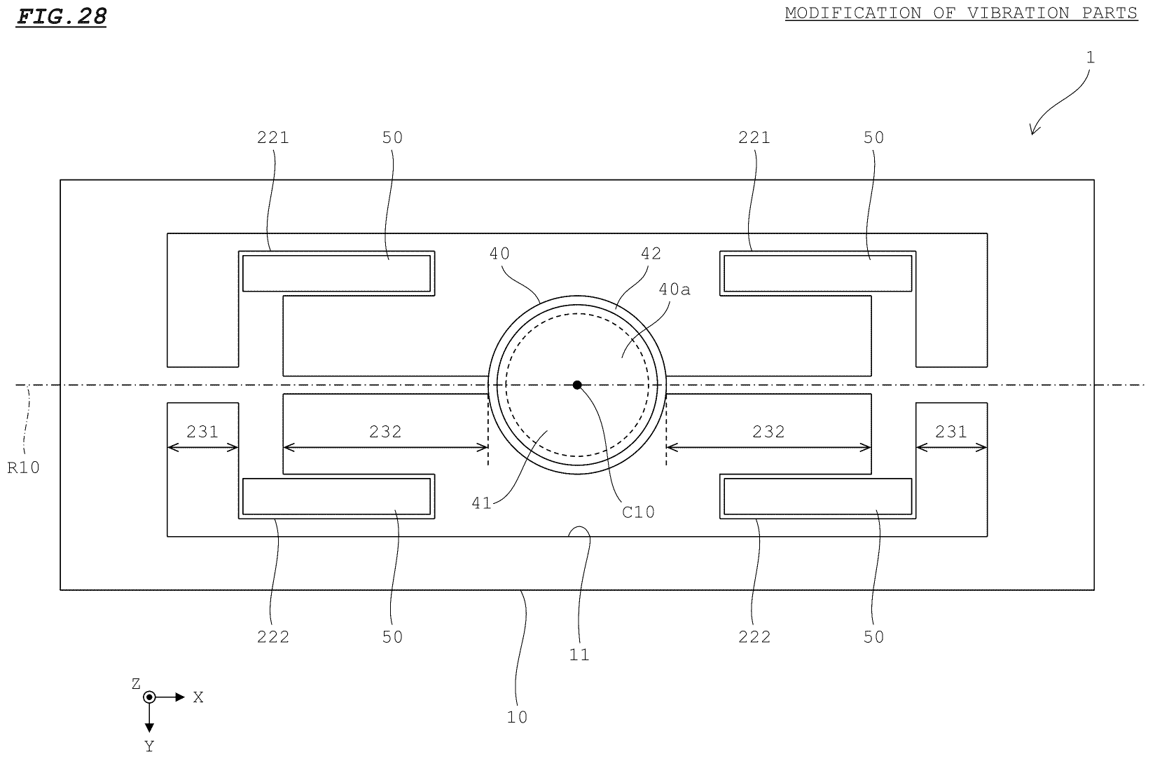

FIG. 28 is a plan view schematically showing a configuration of an optical reflection element 1 according to this modification.

The optical reflection element 1 includes a fixation part 10, a pair of vibration parts 221, a pair of vibration parts 222, a pair of second support parts 231, a pair of first support parts 232, a movable part 40, and four drive parts 50. The optical reflection element 1 is configured to be symmetrical in the X-axis direction and the Y-axis direction about a center C10. In FIG. 28, for convenience, the same components as those in Embodiment 1 shown in FIG. 1 are denoted by the same reference characters. Hereinafter, the configuration different from that of Embodiment 1 will be described.

The vibration parts 221 and 222 each have an L-shape in a plan view. The vibration parts 221 and 222 each have a shape that extends in the X-axis direction, in the vicinity of a distal end thereof, and each have a shape that extends in the Y-axis direction, in the vicinity of the connection to the second support part 231 and the first support part 232. In the vicinity of the rotation axis R10, the vibration parts 221 and 222 are connected to the fixation part 10 via the second support parts 231 and are connected to the movable part 40 via the first support parts 232. The vibration parts 221 are placed on the Y-axis negative side of the rotation axis R10, and the vibration parts 222 are placed on the Y-axis positive side of the rotation axis R10. The second support parts 231 and the first support parts 232 extend in the X-axis direction along the rotation axis R10. The vibration parts 221 and 222 located on the X-axis positive side or the X-axis negative side of the movable part 40 have a tuning fork shape in a plan view.

The drive parts 50 are placed on the upper surfaces of the vibration parts 221 and 222. The drive parts 50 are connected to electrodes on the fixation part 10 via wires on the vibration parts 221 and 222, the second support part 231, and the fixation part 10. Cables (external wires) connected to an external device are connected to the electrodes on the fixation part 10 by wire bonding.

When drive voltages are applied to the drive parts 50 on the vibration parts 221, the piezoelectric layers in the drive parts 50 on the vibration parts 221 become deformed due to an inverse piezoelectric effect, so that the vibration parts 221 vibrate so as to bend. Meanwhile, when drive voltages having a phase opposite to that of the drive voltages applied to the drive parts 50 on the vibration parts 221 are applied to the drive parts 50 on the vibration parts 222, the piezoelectric layers in the drive parts 50 on the vibration parts 222 become deformed due to an inverse piezoelectric effect, so that the vibration parts 222 vibrate so as to bend. Accordingly, due to the deformation of the vibration parts 221 and 222, the movable part 40 rotates about the rotation axis R10 as in Embodiment 1.

In this modification as well, the movable part 40 is configured in the same manner as in Embodiment 1. That is, as shown in FIG. 5A and FIG. 5B, at least a part of the active layer 103 is removed in the rib portion 42. Accordingly, as in Embodiment 1, the expansion of the oxide film 102 is less likely to propagate to the active layer 103, so that bending is less likely to occur in the active layer 103 of the center portion 41.

In Embodiments 2 and 3 and the modifications described above as well, the meander-shaped vibration parts 21 to 24 of the optical reflection element 1 may be composed of tuning-fork-shaped vibration parts 221 and 222 as in this modification.

### Other Modifications

In Embodiment 1 described above, the oxide film 102 in the outer peripheral region A1 of the rib portion 42 is placed over the entire circumference of the outer peripheral region A1 but may be placed over only a part of the outer peripheral region A1. In addition, in Modification 1 of Embodiment 1 described above, the active layer 103 in the outer peripheral region A1 is placed over the entire circumference of the outer peripheral region A1 but may be placed over only a part of the outer peripheral region A1. In addition, in Modification 3 of Embodiment 1 described above, the oxide film 102 and the active layer 103 in the outer peripheral region A1 are placed over the entire circumference of the outer peripheral region A1 but may be placed over only a part of the outer peripheral region A1. In addition, in Modification 3 of Embodiment 1 described above, at least a part of the active layer 103 in the outer peripheral region A1 may be removed.

In the embodiments and the modifications described above, two drive units are placed with the movable part 40 located therebetween as shown in FIG. 1 and FIG. 28, but one of the two drive units may be omitted. For example, in Embodiment 1 shown in FIG. 1, the components on the X-axis positive side of the movable part 40 may be omitted, and the movable part 40 may be supported by the coupling beam 35 on the X-axis negative side. In the modification of the vibration parts shown in FIG. 28, the components on the X-axis positive side of the movable part 40 may be omitted, and the movable part 40 may be supported by the first support part 232 on the X-axis negative side.

In the embodiments and the modifications described above, the rib portion 42 is formed over the entire circumference in the outer peripheral region of the movable part 40 but may be formed in a part of the outer peripheral region of the movable part 40. In this case, a portion of the outer peripheral region of the movable part 40 where the rib portion 42 is not formed is composed only of the active layer 103. In the modification of the reflection surface described above, the optical reflection film 45 is separately placed on the upper surface of the active layer 103, and the upper surface of the optical reflection film 45 is used as the reflection surface 40a, but in this configuration, another optical reflection film may be further placed on the back surface of the center portion 41 of the movable part 40.

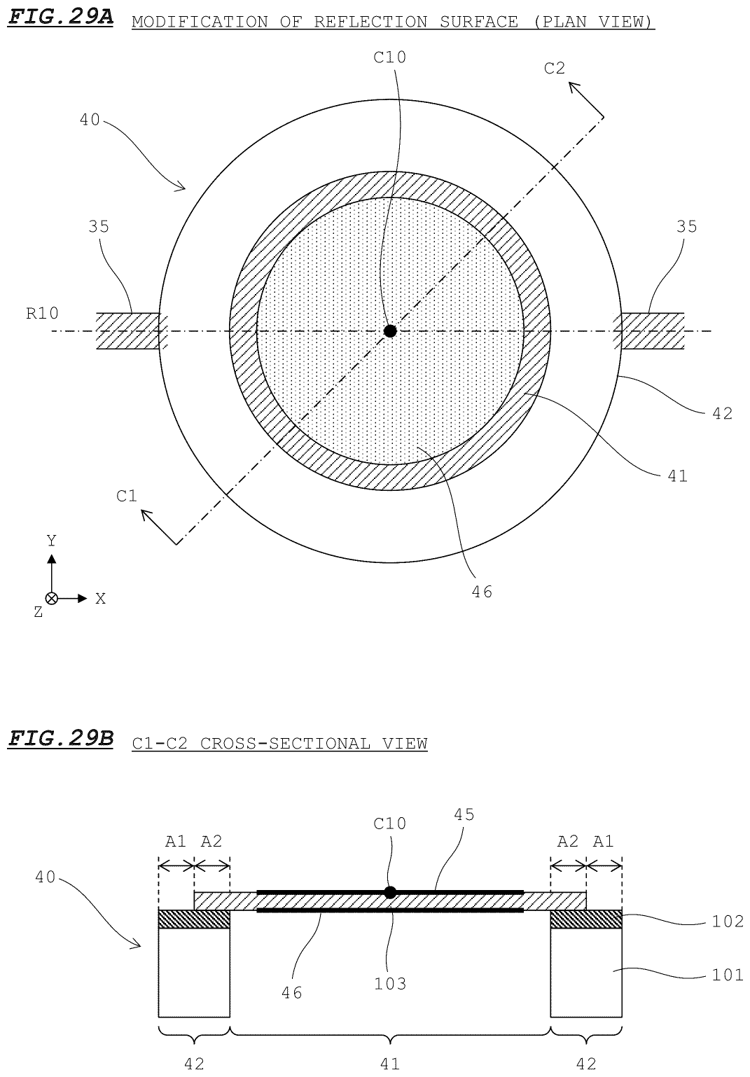

FIG. 29A and FIG. 29B are respectively a plan view and a cross-sectional view schematically showing a configuration of a movable part 40 according to this modification. FIG. 29A shows a plan view of an area around the movable part 40 when viewed from the back surface side.

In this modification, compared to the modification of the reflection surface shown in FIG. 27A and FIG. 27B, an optical reflection film 46 is formed on the back surface of the center portion 41 of the movable part 40. The optical reflection film 46 is made of a material having a high reflectance (e.g., a metal or metal compound such as gold, silver, copper, or aluminum, silicon dioxide, titanium dioxide, or the like). The optical reflection film 46 may be composed of a dielectric multilayer film.

In FIG. 29A and FIG. 29B, the optical reflection film 46 is formed inside the center portion 41 in a plan view but may be formed in the same range as the center portion 41 or may be formed outside the center portion 41 as long as the optical reflection film 46 is within the range of the active layer 103.

In this modification, even if stress is generated in the optical reflection film 45 formed on the upper surface of the active layer 103 due to temperature changes, etc., this stress is alleviated by stress generated in the optical reflection film 46 on the back surface side. Therefore, occurrence of strain in the center portion 41 of the movable part 40 due to the stress in the optical reflection film 45 generated due to temperature changes, etc., can be suppressed.

In order to effectively cancel out the stress generated in the optical reflection film 45 on the upper surface side by the stress in the optical reflection film 46 on the back surface side, it is preferable that the optical reflection film 46 on the back surface side is made of the same material as the optical reflection film 45 on the upper surface side, and it is preferable that the optical reflection film 46 is placed in a region corresponding to the optical reflection film 45 on the upper surface side.

The deflection angle of the movable part 40 can be detected by irradiating the optical reflection film 46 on the back surface side with light and receiving the reflected light thereof with a PSD (position sensitive detector). If the reflectance of the back surface of the movable part 40 is high to a certain extent, the deflection angle of the movable part 40 can be detected using the above configuration without placing the optical reflection film 46. However, by placing the optical reflection film 46, the reflectance is further increased, so that the deflection angle of the movable part 40 can be detected properly.

In addition to the above, various modifications can be made as appropriate to the embodiments of the present invention without departing from the scope of the technical idea defined by the claims.

### ADDITIONAL NOTE

The following technologies are disclosed by the description of the above embodiments.

### (Technology 1)

An optical reflection element including:
a fixation part; and
a movable part supported by the fixation part so as to be rotatable about a rotation axis, having a reflection surface on a center portion of an upper surface thereof, and having a rib portion on an outer peripheral region of a lower surface thereof, wherein
the center portion of the movable part has a structure in which a base layer and an oxide film are removed from an SOI wafer in which the base layer, the oxide film, and an active layer are stacked, and
the rib portion has a structure in which at least a part of the active layer is removed from the SOI wafer.

In the production of the SOI wafer, the base layer is thermally oxidized at about 1100° C. to form the oxide film on the surface of the base layer, and the active layer is then bonded to the oxide film. The base layer has a higher thermal expansion coefficient than the oxide film, and when the base layer returns to room temperature, the base layer attempts to shrink more than the oxide film. Thus, at this time, compressive stress is applied from the base layer to the oxide film. When such an SOI wafer is processed to remove the base layer and the oxide film from the center region of the movable part and form the rib portion in the outer peripheral region, the above compressive stress applied to the oxide film of the rib portion is partially released due to the removal of the base layer in the center region, so that the oxide film expands. Accordingly, a force is applied from the oxide film to the active layer of the center portion in a direction toward the center of the center portion, so that bending occurs in the active layer of the center portion. In contrast, according to this technology, since at least a part of the active layer is removed in the rib portion, the expansion of the oxide film is less likely to propagate to the active layer, so that bending is less likely to occur in the active layer of the center portion. Therefore, when forming the rib portion in the movable part using the SOI wafer, bending of the movable part can be suppressed.

### (Technology 2)

The optical reflection element according to technology 1, wherein the rib portion has a structure in which at least a part of the oxide film is further removed from the SOI wafer.

According to this technology, the volume of the oxide film, which is the source of bending, is decreased, so that displacement of the oxide film due to expansion thereof is further decreased. Accordingly, bending of the center portion can be further suppressed.

### (Technology 3)

The optical reflection element according to technology 1 or 2, wherein the center portion and the rib portion are connected via a flexible spring portion.

According to this technology, the expansion of the oxide film of the rib portion is further less likely to be transmitted to the active layer of the center portion, so that bending of the center portion can be further suppressed.

### (Technology 4)

The optical reflection element according to technology 3, wherein the rib portion has a configuration in which the oxide film and the active layer in a region other than in a region connected to the spring portion is removed from the SOI wafer.

According to this technology, the oxide film and the active layer required for the region where the spring portion and the rib portion are connected are left, and the entirety of the oxide film and the entirety of the active layer are removed from the rib portion. Accordingly, since the oxide film of the rib portion is almost completely eliminated, bending of the center portion can be further suppressed.

### (Technology 5)

The optical reflection element according to technology 3 or 4, wherein a distance from a center of the center portion to an inner periphery of the rib portion is shorter than a distance from the center of the center portion to a position at which the spring portion and the rib portion are connected.

According to this technology, the rib portion can be placed closer to the center portion, so that the weight of the rib portion can be decreased. Accordingly, a decrease in the driving efficiency of the movable part can be suppressed.

### (Technology 6)

The optical reflection element according to any one of technologies 3 to 5, wherein the spring portion is made of the same material as the center portion.

According to this technology, the spring portion and the center portion can be formed at the same time, so that the manufacturing process of the optical reflection element is simplified.

### (Technology 7)

The optical reflection element according to any one of technologies 1 to 6, wherein the movable part is configured to be line-symmetrical with respect to a straight line that passes through a center of the center portion and is perpendicular to the rotation axis.

According to this technology, the weight balance of the movable part across the straight line that passes through the center and is perpendicular to the rotation axis can be made equal. Thus, the movable part can be driven appropriately.

### (Technology 8)

The optical reflection element according to any one of technologies 1 to 7, wherein the movable part is configured such that bending that occurs in the center portion due to expansion of the oxide film is substantially symmetrical about a central axis of the center portion.

According to this technology, reflected light that is reflected by the movable part is distributed substantially symmetrically with respect to the optical axis thereof, so that it becomes easier to design an optical system in the subsequent stage on which the reflected light is incident.

### (Technology 9)

The optical reflection element according to technology 8, wherein configurations of the movable part at positions with substantially equal angles in a circumferential direction with respect to a center of the center portion, are substantially the same as each other.

According to this technology, the movable part can be easily configured such that bending that occurs in the center portion is substantially symmetrical about the central axis of the center portion.

### (Technology 10)

The optical reflection element according to any one of technologies 1 to 9, wherein the rib portion has a structure in which the active layer having a predetermined width is removed from the SOI wafer along a circumferential direction of the movable part.

According to this technology, the expansion of the oxide film of the rib portion is less likely to be transmitted to the active layer of the center portion evenly over the entire circumference, so that bending of the center portion can be suppressed evenly over the entire circumference.

### (Technology 11)

The optical reflection element according to any one of technologies 1 to 10, further including an optical reflection film on an upper surface of the active layer.

According to this technology, the reflectance can be improved compared to the case where the upper surface of the active layer is used as the reflection surface.

### (Technology 12)

The optical reflection element according to technology 11, further including another optical reflection film on a back surface of the center portion of the movable part.

According to this technology, even if stress is generated in the optical reflection film formed on the upper surface of the active layer due to temperature changes, etc., this stress is alleviated by stress generated in the optical reflection film on the back surface side. Therefore, occurrence of strain in the center portion of the movable part due to the stress in the optical reflection film generated due to temperature changes, etc., can be suppressed.

What is claimed is:

1. An optical reflection element comprising:
a fixation part; and
a movable part supported by the fixation part so as to be rotatable about a rotation axis, having a reflection surface on a center portion of an upper surface thereof, and having a rib portion on an outer peripheral region of a lower surface thereof, wherein
the center portion of the movable part has a structure in which a base layer and an oxide film are removed from an SOI wafer in which the base layer, the oxide film, and an active layer are stacked, and
the rib portion has a structure in which at least a part of the active layer is removed from the SOI wafer.

2. The optical reflection element according to claim 1, wherein the rib portion has a structure in which at least a part of the oxide film is further removed from the SOI wafer.

3. The optical reflection element according to claim 1, wherein the center portion and the rib portion are connected via a flexible spring portion.

4. The optical reflection element according to claim 3, wherein the rib portion has a configuration in which the oxide film and the active layer in a region other than in a region connected to the spring portion is removed from the SOI wafer.

5. The optical reflection element according to claim 3, wherein a distance from a center of the center portion to an inner periphery of the rib portion is shorter than a distance from the center of the center portion to a position at which the spring portion and the rib portion are connected.

6. The optical reflection element according to claim 3, wherein the spring portion is made of the same material as the center portion.

7. The optical reflection element according to claim 1, wherein the movable part is configured to be line-symmetrical with respect to a straight line that passes through a center of the center portion and is perpendicular to the rotation axis.

8. The optical reflection element according to claim 1, wherein the movable part is configured such that bending that occurs in the center portion due to expansion of the oxide film is substantially symmetrical about a central axis of the center portion.

9. The optical reflection element according to claim 8, wherein configurations of the movable part at positions with substantially equal angles in a circumferential direction with respect to a center of the center portion, are substantially the same as each other.

10. The optical reflection element according to claim 1, wherein the rib portion has a structure in which the active layer having a predetermined width is removed from the SOI wafer along a circumferential direction of the movable part.

11. The optical reflection element according to claim 1, further comprising an optical reflection film on an upper surface of the active layer.

12. The optical reflection element according to claim 11, further comprising another optical reflection film on a back surface of the center portion of the movable part.
